(19) United States
(12) Patent Application Publication
(10) Pub. No.: US 2026/0278275 A1
(43) Pub. Date: Sep. 17, 2026

(54) Systems and Methods for Recognition-Based Natural Language Processing

(71) Applicant: Jonathan Washburn, Austin, TX (US)

(72) Inventor: Jonathan Washburn, Austin, TX (US)

(21) Appl. No.: 19/564,045

(22) Filed: Mar. 11, 2026

Related U.S. Application Data
(60) Provisional application No. 63/771,459, filed on Mar. 13, 2025.

(51) Int. Cl. G06F 40/284

(52) U.S. Cl. CPC G06F 40/284

(57) ABSTRACT

A recognition-based natural language processing system receives outputs from a pre-trained language model or base language model and applies a shared recognition coverage function F_cov(r)=r/(r+X_opt), where X_opt=phi/pi, to improve semantic prediction and language understanding. The system can generate recognition-enhanced embeddings from context-derived semantic distance, compute contextual coherence from pairwise embedding relationships weighted by positional distance, compute confidence-weighted sentiment outputs from raw sentiment scores and classifier confidence values, and compute recognition-based reranking weights for tokens, passages, documents, or other candidates. In some embodiments, the system combines multiple recognition-derived quantities into a bounded combined score used to rank or select outputs for classification, retrieval, generation, segmentation, moderation, or related natural language processing tasks. The disclosed architecture operates as a model-agnostic post-processing framework compatible with existing language-model pipelines.

### CROSS-REFERENCE TO RELATED APPLICATIONS

This application claims benefit of priority to U.S. Provisional Patent Application No. 63/771,459, titled “Recognition-Based Natural Language Processing System: Computational Methods and Systems for Improved Semantic Prediction and Language Understanding using Recognition Physics” filed on Mar. 13, 2025.

### BACKGROUND

The present invention relates generally to natural language processing, computational linguistics, and machine-implemented language-model post-processing. More particularly, the present invention relates to systems and methods for improving semantic prediction, contextual interpretation, coherence evaluation, confidence-sensitive sentiment handling, and candidate reranking in natural language processing pipelines using a bounded recognition-based weighting framework. Modern natural language processing systems, including transformer-based models, embedding models, retrieval systems, and classifier systems, have substantially improved automated text generation, retrieval, classification, and interpretation. However, such systems still often exhibit weaknesses when token meaning depends heavily on surrounding context, when coherence must be assessed across a sentence or passage rather than at an isolated token level, when low-confidence sentiment or classification outputs are consumed too aggressively, or when ranking systems rely too heavily on hard cutoffs that discard borderline but still useful candidates.

Conventional language-model outputs are frequently produced on different native scales and are often handled by separate scoring heuristics that do not share a common bounded weighting basis. As a result, semantically ambiguous terms may be interpreted incorrectly, structurally incoherent outputs may not be adequately distinguished from coherent outputs, low-confidence sentiment predictions may be treated too similarly to high-confidence predictions, and retrieval or generation candidates that fall near a threshold may be discarded despite retaining practical value. Accordingly, there remains a need for a natural language processing architecture that can operate on outputs of existing pre-trained or base models, that can improve context-sensitive embedding behavior, contextual coherence assessment, confidence-weighted interpretive outputs, and candidate reranking, and that can do so using a unified recognition-based weighting framework without requiring reformulation of the underlying language model itself.

### SUMMARY

The present invention provides recognition-based natural language processing systems and methods that operate on outputs of existing language models, embedding models, classifier systems, retrieval systems, or related NLP systems to improve semantic prediction, context-sensitive interpretation, contextual coherence evaluation, confidence-sensitive interpretive weighting, and candidate reranking. In embodiments, the invention uses a shared recognition-based weighting framework derived from X_opt=phi/pi and a recognition coverage function F_cov(r)=r/(r+X_opt) for r>=0, thereby allowing different classes of nonnegative NLP quantities to be processed through a common bounded and monotone mapping. Using that framework, the invention can generate recognition-enhanced embeddings, compute contextual coherence values, compute confidence-weighted sentiment outputs, compute recognition-based reranking weights, and, in some embodiments, combine multiple such outputs into a unified semantic prediction score for downstream use in classification, generation, retrieval, segmentation, moderation, ranking, or related tasks.

In one embodiment, a recognition-based natural language processing system receives an input text or query, provides the input to a pre-trained language model or base language model, and receives base embeddings and raw prediction outputs from that model. A recognition semantic embedding workflow then defines a context window for a selected token, computes a context embedding from embeddings within that context window, computes a semantic distance between the context embedding and the selected token's base embedding, computes a recognition scale factor using the recognition coverage function, and generates a recognition-enhanced embedding by applying the recognition scale factor to a context-alignment correction. In embodiments, the resulting recognition-enhanced embedding can be used for ambiguity resolution, semantic search, question answering, classification, summarization, machine translation evaluation, or other context-sensitive natural language processing tasks.

In another embodiment, the system computes one or more additional recognition-based outputs from the model-derived quantities. For example, a recognition contextual coherence workflow can compute a coherence score for a sentence, passage, or other text unit by aggregating pairwise semantic contributions weighted according to positional distance. A recognition sentiment analysis workflow can compute a confidence-weighted sentiment output from a raw sentiment score and a classifier confidence. A recognition token reranking workflow can compute reranking weights for candidate tokens, passages, documents, answers, or hypotheses from associated relevance quantities. In some embodiments, a combined semantic prediction workflow receives an alignment-related quantity, a coherence-related quantity, a confidence-weighted quantity, and a reranking-related quantity, computes mixture weights from X_opt, computes a combined score, and selects or ranks a candidate according to that combined score.

Accordingly, the invention provides a modular, bounded, and model-agnostic architecture for recognition-based post-processing of natural language processing outputs.

### BRIEF DESCRIPTION OF THE DRAWINGS

The various advantages of the examples will become apparent to one skilled in the art by reading the following specification and appended claims, and by referencing the following drawings, in which:

FIG. 1 is a schematic block diagram illustrating an example recognition-based natural language processing system architecture including a baseline language-model stage, recognition-based processing modules, an optional combined-scoring stage, and a downstream task stage.

FIG. 2 is a flow diagram illustrating an example recognition semantic embedding workflow in which a token sequence and corresponding base embeddings are processed using a context-derived embedding, a semantic-distance computation, and a recognition-based scaling operation to generate a recognition-enhanced embedding.

FIG. 3 is a flow diagram illustrating an example recognition contextual coherence workflow in which embeddings associated with a text unit are processed using pairwise similarity computations and positional weighting to generate a contextual coherence measure.

FIG. 4 is a flow diagram illustrating an example recognition sentiment analysis workflow in which a raw sentiment-related output and an associated confidence value are processed using a recognition-based weighting operation to generate a confidence-weighted sentiment output.

FIG. 5 is a flow diagram illustrating an example recognition token reranking workflow in which candidate outputs and associated relevance values are processed to generate recognition-based reranking weights, ranked candidates, and, in some embodiments, normalized candidate weights and selected outputs.

FIG. 6 is a flow diagram illustrating an example combined semantic prediction workflow in which multiple recognition-derived quantities are combined using mixture weights to generate a combined score and a downstream candidate-selection result.

FIG. 7 is a schematic diagram illustrating an example computing environment for implementing one or more of the disclosed recognition-based natural language processing operations.

FIG. 8 is a flow diagram illustrating an example ambiguity-resolution workflow in which an ambiguous token is evaluated against candidate senses using contextual information and recognition-based comparison logic.

FIG. 9 is a flow diagram illustrating an example retrieval and reranking workflow in which retrieved passages or other candidates are reranked using recognition-based weighting prior to downstream generation or output selection.

### DETAILED DESCRIPTION

As used herein, the term “Recognition Science” or “RS” refers, for purposes of this application, to the mathematical framework from which the recognition coverage function and the constant X_opt are derived and by which certain boundedness, monotonicity, and related formal properties are characterized. The present application uses that framework in a narrow, application-specific manner directed to natural language processing. Unless expressly stated otherwise, references to RS in this application are directed to the disclosed mathematical basis for the weighting and modulation functions used herein and are not intended to import unrelated subject matter outside the scope of the claimed natural language processing methods and systems.

As used herein, the symbol phi denotes the golden ratio and may be defined as phi=(1+sqrt(5))/2. As used herein, the symbol pi denotes the circular constant. As used herein, the term X_opt denotes an RS-derived constant defined as X_opt=phi/pi. In embodiments, X_opt functions as a shared recognition-scale constant used across multiple natural language processing operations, including embedding modulation, contextual coherence weighting, confidence weighting, reranking, and optional combined scoring. In embodiments, use of X_opt provides a common scaling basis across multiple subsystem types without requiring the introduction of additional empirical coefficients into the recognition mappings themselves.

As used herein, the term “recognition coverage function” refers to the function F_cov(r)=r/(r+X_opt) for r>=0. The argument r may be any nonnegative quantity suitable for recognition-based weighting, including but not limited to a semantic distance, a positional distance, a classifier confidence quantity, a relevance quantity, a transformed score quantity, or another nonnegative model-derived or system-derived value. In embodiments, the recognition coverage function is bounded, continuous for r>=0, monotone increasing in r, equal to zero at r=0, and less than one for finite nonnegative r. In embodiments, those properties make the function suitable for producing soft, non-thresholded weighting values that increase with the magnitude of the input quantity while remaining bounded.

In some embodiments, a downstream selection decision is based on comparing a recognition-derived score, a combined semantic prediction score, or another candidate-associated score to one or more criteria. For example, a candidate output may be accepted when the score exceeds an acceptance threshold tau, may be required to exceed a next-best candidate by at least a margin m, and may be treated as ambiguous when two or more candidates are within a closeness interval epsilon of a highest score, in which case the system escalates to a fallback handling mode. These criteria may be applied to candidate senses, retrieved passages, documents, answers, beam hypotheses, labels, or other candidate outputs produced by a baseline model, retriever, reranker, or downstream task component.

As used herein, the term “base embedding” refers to a vector representation generated for a token, word, subword, phrase, sentence, passage, or other language unit by a baseline model, such as a pre-trained language model, embedding model, encoder, decoder, transformer, sequence model, retrieval model, classifier backbone, or another natural language representation system. Abase embedding may be generated directly by a model during inference, may be retrieved from storage after prior generation, or may be received from an external model or service. A base embedding is not limited to any particular dimensionality, architecture, training objective, tokenization scheme, or implementation format.

As used herein, the term “context embedding” refers to a vector representation associated with a context surrounding, preceding, following, containing, or otherwise related to a selected language unit. In embodiments, a context embedding may be computed as a mean, weighted mean, aggregate, pooled representation, attention-derived representation, or another derived representation based on one or more surrounding base embeddings. In embodiments, the relevant context may be defined by a fixed window, adaptive window, sentence boundary, clause boundary, paragraph boundary, conversation-history boundary, retrieval context, document context, session context, or another scope definition. A context embedding therefore represents a contextualized reference against which a selected base embedding can be compared or toward which a selected base embedding can be modulated.

As used herein, the term “semantic distance” refers to a nonnegative measure of divergence, separation, mismatch, dissimilarity, or offset between two vector representations, such as between a base embedding and a context embedding. In embodiments, semantic distance may be computed using cosine distance, Euclidean distance, angular distance, normalized divergence, or another nonnegative comparison metric. Where a metric can take negative values in native form, the metric may be transformed, shifted, clipped, rectified, or otherwise converted into a nonnegative quantity before use with the recognition coverage function. Unless the context clearly requires otherwise, semantic distance includes both directly computed distances and semantically equivalent nonnegative divergence quantities used for recognition-based scaling. As used herein, the term “relevance metric” refers to a quantity indicative of estimated relevance, suitability, match quality, rank-worthiness, semantic fit, retrieval utility, generation utility, or candidate desirability for a token, passage, document, answer, hypothesis, or other candidate output. A relevance metric may be produced by a retriever, reranker, language model, search engine, classifier, recommendation system, or another computational component. In embodiments, a relevance metric may include a retrieval score, similarity score, confidence score, ranking score, transformed logit, transformed probability-derived score, BM25-derived score, dense retrieval score, hybrid retrieval score, or another candidate-associated scalar value. Where a relevance metric is not nonnegative, it may be transformed into a nonnegative quantity prior to application of the recognition coverage function.

As used herein, the term “confidence” refers to a scalar value indicative of certainty, estimated reliability, predictive strength, posterior support, margin strength, ranking assurance, or another model-produced or system-produced measure associated with a prediction, classification, label assignment, or candidate output. Confidence may be generated natively by a classifier or may be derived from another signal, such as a posterior probability, softmax score, logit margin, agreement score, ensemble agreement measure, calibration output, confidence head output, or transformed uncertainty quantity. In embodiments, confidence is treated as a nonnegative input to a recognition-based weighting process. Where a source measure is signed or not directly nonnegative, the source measure may be converted into a usable nonnegative quantity before such weighting is applied.

As used herein, the term “candidate” refers to any selectable or rankable language-related item that may be evaluated, weighted, compared, reranked, filtered, retained, suppressed, or output by the disclosed system. A candidate may include, by way of non-limiting example, a token candidate, next-token candidate, beam-search hypothesis, candidate word sense, candidate label, candidate span, candidate answer, candidate sentence, candidate passage, candidate document, candidate retrieval result, candidate completion, or candidate action. Unless expressly stated otherwise, the term candidate is intended to be broad enough to encompass both intermediate computational objects and final output options.

As used herein, the term “language model” refers to any computational model configured to process, encode, decode, score, classify, generate, embed, predict, or otherwise operate on natural language or language-like sequences. A language model may include a transformer model, encoder-only model, decoder-only model, encoder-decoder model, embedding model, sequence classifier, token classifier, retrieval model, masked language model, autoregressive model, recurrent model, statistical language model, hybrid model, multimodal language-capable model, or another machine-learning-based or algorithmic natural language processing model. The disclosed invention is not limited to a particular model family, parameter count, tokenizer, vocabulary, training corpus, training method, or deployment topology unless expressly recited in a claim.

As used herein, the term “post-processing layer” refers to a computational stage, wrapper, module, routine, pipeline component, or system layer that receives one or more outputs from a baseline model and performs additional processing on those outputs without requiring modification of the underlying trained weights of that baseline model. In embodiments, a post-processing layer may receive embeddings, logits, probabilities, confidence values, candidate lists, retrieval results, similarity values, attention-derived values, or other intermediate or final outputs from a baseline model and may generate modified or additional outputs based on recognition-based computations. A post-processing layer may operate synchronously with the baseline model, asynchronously relative to the baseline model, locally, remotely, inline, as a service, or as a library component.

As used herein, the phrase “without modifying the underlying language model” means that the disclosed recognition-based operations may be performed without altering stored base-model parameters that define the baseline model at inference time. This phrase does not exclude ordinary deployment choices such as selecting a model, selecting a prompt format, selecting a tokenizer, caching model outputs, batching inference calls, choosing hardware acceleration, selecting a context window size, selecting a distance metric, or configuring an external wrapper or downstream decision rule. This phrase also does not exclude embodiments in which the baseline model has separately been fine-tuned before being used together with the disclosed post-processing operations.

As used herein, the term “recognition scale factor” refers to a weighting value computed from a nonnegative input, such as semantic distance or another quantity, using the recognition coverage function or an equivalent disclosed recognition-based mapping. In embodiments, a recognition scale factor can determine the extent to which a representation, score, ranking value, or other quantity is adjusted toward a context-derived, confidence-derived, distance-derived, or relevance-derived result. In embodiments, the recognition scale factor is bounded below by zero and bounded above by one in the limit for finite nonnegative inputs, thereby supporting soft and controlled modulation rather than unbounded amplification.

As used herein, the term “recognition-enhanced embedding” refers to an embedding generated by modifying a base embedding according to a recognition-derived scaling operation that depends on a comparison between the base embedding and a context embedding. In embodiments, the recognition-enhanced embedding can move the base embedding toward a context-derived embedding by an amount determined from semantic divergence. In embodiments, where divergence is small or zero, the resulting recognition-enhanced embedding may remain close to or identical to the original base embedding. In embodiments, where divergence is larger, the recognition-enhanced embedding may incorporate a larger context-alignment correction while remaining bounded by the disclosed weighting behavior.

As used herein, the term “context window” refers to a defined set of context items used to compute a context embedding or other context-derived quantity for a selected language unit. A context window may be defined in terms of token count, position range, sentence membership, paragraph membership, discourse region, dialogue turn history, retrieval neighborhood, sequence span, semantic neighborhood, or another contextual scope. The size and definition of the context window may be fixed, adaptive, learned, heuristic, dynamic, rule-based, or otherwise selected according to implementation needs. A context window therefore need not be limited to immediately adjacent tokens.

As used herein, the term “coherence” or “contextual coherence” refers to a scalar or derived quantity indicative of semantic relatedness, discourse continuity, topical consistency, interpretive compatibility, or another measure of meaningful fit among multiple language units in a text. In embodiments, contextual coherence may be computed by aggregating pairwise or grouped interactions among embeddings, including recognition-enhanced embeddings, and weighting those interactions according to positional distance or another quantity. A coherence quantity may be used for scoring generated text, detecting topical boundaries, evaluating readability, ranking outputs, filtering outputs, or otherwise assessing natural language quality or structure.

As used herein, the term “sentiment” refers broadly to any scalar, categorical, or structured output reflecting polarity, affect, tone, attitude, toxicity, moderation status, emotional classification, review quality, approval tendency, or another interpretive label associated with text. A sentiment quantity may be binary, ternary, multiclass, continuous, signed, unsigned, or otherwise structured. Unless the context requires otherwise, discussion of sentiment in this application includes analogous classification outputs for moderation, safety, toxicity, or emotion-related inference where confidence weighting is applied in the same general manner.

As used herein, the term “reranking” refers to reordering, reweighting, filtering, selecting, rescoring, or reprioritizing one or more candidates based on one or more computed values after an initial candidate set has already been produced. Reranking may be applied to tokens, passages, documents, retrieval results, beam hypotheses, candidate answers, labels, or other candidate outputs. In embodiments, reranking is soft rather than threshold-exclusive, such that multiple candidates can remain available with different weights even if only one candidate is ultimately selected for output.

As used herein, the term “nonnegative” refers to greater than or equal to zero. Where a disclosed operation requires a nonnegative input to the recognition coverage function, any suitable transformation may be applied to convert an original score, distance, confidence, or relevance quantity into a nonnegative form, provided the transformed quantity preserves usable ordering or weighting information for the intended embodiment. Such transformations may include absolute value, shift, clipping, rectification, normalization, or another monotone or otherwise suitable transform.

As used herein, references to “bounded” quantities mean quantities constrained within a finite interval under the disclosed operating conditions. In particular, where the recognition coverage function is applied to a finite nonnegative input, the resulting weighting value is bounded between zero and one, excluding one for finite nonnegative inputs. References to “monotone” or “monotonic” mean that a quantity varies in a single direction with respect to its argument over the stated domain, such as increasing as the input increases over r>=0. These terms are used in their mathematical sense unless the context clearly indicates a different usage.

As used herein, references to “parameter-free” or “without additional empirical tuning coefficients” mean that the recognition mappings themselves can be expressed using the shared constant X_opt without requiring the addition of further empirically fitted coefficients inside those mappings. This usage does not exclude ordinary engineering choices outside the recognition mapping itself, such as model selection, tokenizer selection, context-window size, distance metric selection, batching strategy, retrieval depth, normalization choices, latency tradeoffs, deployment topology, threshold selection for downstream acceptance or rejection, or other implementation-specific configuration choices.

As used herein, the phrase “machine-verified” refers to formal within-model derivations under adopted RS premises and does not, by itself, assert empirical benchmark performance, real-world superiority, or experimental validation across datasets. Accordingly, a statement that a property is machine-verified means that, within the adopted formal premises, the corresponding relationship, bound, monotonicity property, or other formal result has been established in a machine-checked manner. Such usage is distinct from empirical testing, benchmarking, production evaluation, or statistical validation, each of which may be described separately where appropriate.

Unless expressly stated otherwise, mathematical expressions appearing in this application are intended to define relationships among disclosed quantities and are not limited to any single programming language, proof assistant, machine-learning framework, or numerical library. Equivalent computational implementations may use floating-point arithmetic, fixed-point arithmetic, symbolic computation, approximate computation, vectorized tensor computation, hardware-accelerated computation, or other suitable computational techniques consistent with the disclosed relationships.

Unless expressly stated otherwise, examples, use cases, data types, model types, scoring choices, deployment choices, and implementation details described herein are illustrative and non-limiting. A person of ordinary skill in the art, reading this disclosure, will understand that disclosed features may be used individually, jointly, in subsets, or in alternative combinations consistent with the claimed subject matter. Likewise, a description that an embodiment “can,” “may,” or “in some embodiments” perform a given operation is intended to make clear that such operation is optional unless expressly required by a claim.

Recognition Science, as used in this application, is employed as a narrow mathematical foundation for certain weighting, scaling, and bounded-modulation operations applied to outputs of natural language processing systems. The present disclosure does not require adoption of every broader proposition, domain-specific extension, or independent theoretical claim that may appear elsewhere within Recognition Science materials. Instead, the present disclosure uses only the portions of that framework needed to define a shared recognition-scale constant, a recognition coverage function, and associated bounded and monotone weighting behavior for natural language processing operations such as embedding modulation, contextual coherence weighting, confidence weighting, reranking, and optional combined scoring.

In the mathematical posture used here, Recognition Science is treated as a cost-first framework. In that framework, a recognition cost functional is used as the starting point for deriving a particular informational scale and associated weighting behavior. The primitive relation is the Recognition Composition Law, and, under the adopted Recognition Science premises, the recognition cost functional is uniquely expressed as J(x)=0.5*(x+1/x)−1. This expression is symmetric under reciprocal exchange of x and 1/x, is nonnegative over positive real inputs, and has a minimum at x=1. In the present application, this cost-based foundation is not introduced for abstraction alone, but because it provides the basis for the shared constant and bounded weighting map used throughout the disclosed natural language processing subsystems. Within the adopted Recognition Science premises, the constant phi is forced as the positive solution to x\hat{ }2=x+1, such that phi=(1+sqrt(5))/2. The present application uses that constant together with pi to define X_opt=phi/pi. In embodiments, X_opt serves as a shared informational scaling constant across multiple subsystem types. Rather than assigning a separate empirical coefficient to each subsystem, the disclosed architecture uses the same X_opt in recognition semantic embedding, recognition contextual coherence, recognition sentiment analysis, recognition token reranking, and optional combined scoring. This common-constant approach provides a mathematically unified basis for treating different kinds of nonnegative natural language processing quantities within the same bounded weighting framework. Using X_opt, the present application applies the recognition coverage function F_cov(r)=r/(r+X_opt) for r>=0. In the context of this application, r may represent, for example, a semantic distance, a positional distance, a classifier confidence quantity, a relevance quantity, or another nonnegative quantity produced by or derived from an NLP pipeline. The function F_cov(r) maps such nonnegative inputs into a bounded interval beginning at zero and approaching one for increasing finite values of r, while remaining strictly below one for finite nonnegative inputs. As a result, the function acts as a continuous recognition-based weighting map that can be used to modulate embeddings, pairwise coherence contributions, confidence-scaled sentiment outputs, candidate reranking values, and optional combined decision scores without requiring hard thresholding at the recognition-mapping stage itself.

The cost-first foundation is relevant to the present NLP application because it supplies a principled way to transform measured or derived NLP quantities into bounded control values. In the disclosed system, semantic divergence between a token embedding and a context embedding can be converted into a recognition scale factor; positional separation between token pairs can be converted into a coherence weighting factor; classifier confidence can be converted into a confidence-proportional sentiment weighting factor; and retrieval or generation relevance values can be converted into soft reranking weights. In each of these cases, the same coverage map is used, but the underlying quantity r differs according to subsystem function. Accordingly, the Recognition Science foundation used here is not a separate end in itself, but a unifying mathematical basis for a family of natural language processing operations that all use a bounded, continuous, and monotone recognition mapping.

In embodiments, the function F_cov(r) is particularly useful because it provides continuous weighting rather than discontinuous inclusion-or-exclusion logic. For semantic embedding correction, this permits context-alignment updates that vary according to divergence magnitude rather than switching abruptly between “apply” and “do not apply” states. For contextual coherence, this permits positional weighting that smoothly reflects token separation rather than assigning all token pairs equal value or relying on crude cutoff windows alone. For sentiment analysis, this permits low-confidence outputs to be suppressed continuously relative to higher-confidence outputs rather than treated identically until a threshold is crossed. For reranking, this permits borderline candidates to retain graded influence rather than being discarded solely because they fall slightly below a hard cutoff. Thus, the Recognition Science foundation used in this application is tied directly to practical computational behavior in the disclosed NLP system. The present disclosure also uses the Recognition Science foundation in a deliberately constrained manner to avoid importing subject matter unnecessary to the claimed invention. In particular, this application does not depend on broader Recognition Science propositions concerning unrelated physical, biological, semantic, cosmological, consciousness-related, or other domain-specific theories. The disclosed NLP system does not require acceptance of a universal semantic ontology, a broader meaning theory, or any non-NLP application of the Recognition Science framework. Instead, the application uses only the narrow mathematical components needed to justify the shared use of J(x), phi, X_opt, and F_cov(r) as disclosed recognition-derived constructs for weighting NLP outputs.

Where this application states that certain mathematical properties are “machine-verified,” such usage refers to within-model derivations under the adopted Recognition Science premises and does not by itself represent a claim of empirical benchmark superiority, real-world production dominance, or universal experimental validation. Thus, statements concerning boundedness, monotonicity, symmetry, or related formal properties of the disclosed recognition-based mappings should be understood as mathematical or formal statements within the stated framework. Empirical performance, when discussed elsewhere in the specification, is separate from the formal foundation described in this subsection.

Accordingly, the Recognition Science foundation used in this application may be summarized as follows. First, the adopted framework is cost-first. Second, the primitive relation is the Recognition Composition Law. Third, under the adopted premises, the recognition cost functional is uniquely given by J(x)=0.5*(x+1/x)−1. Fourth, phi is forced as the positive solution to x\hat{ }2=x+1. Fifth, the present application defines X_opt=phi/pi and uses that constant in the recognition coverage function F_cov(r)=r/(r+X_opt). Sixth, the present application applies that function only in the narrow, application-specific context of weighting and modulating NLP outputs. This foundation supplies the common mathematical basis for the subsystem operations described below, while keeping the invention confined to the disclosed natural language processing architecture rather than expanding into unrelated Recognition Science domains.

Referring to FIG. 1, an overall recognition-based natural language processing system (100) can receive an input text or query (110) and provide the input text or query (110) to a pre-trained language model or base language model (120). The pre-trained language model (120) can generate base embeddings and raw prediction outputs (130), which can include, depending on the embodiment, token embeddings, sentence-level or passage-level vector representations, raw sentiment values, classifier confidence values, candidate relevance values, logits, intermediate scoring values, or other model-derived quantities suitable for subsequent recognition-based processing. In the illustrated architecture, the base embeddings and raw prediction outputs (130) are supplied to a recognition semantic embedding module (140), a recognition contextual coherence module (150), a recognition sentiment analysis module (160), and a recognition token reranking module (170). Outputs from one or more of those modules can be provided to a combined scoring module (180), and one or more resulting outputs can be provided to a downstream task module (190) for classification, generation, retrieval, segmentation, moderation, ranking, or other natural language processing operations.

The recognition-based natural language processing system (100) is therefore arranged as an end-to-end modular pipeline in which a baseline language-processing stage produces initial representational and scoring artifacts, and one or more recognition-based post-processing stages transform those artifacts into bounded and operationally useful downstream outputs. In embodiments, the input text or query (110) can be a sentence, prompt, document, message, search query, question, dialogue turn, content item, translation candidate, or any other natural-language-bearing input. The pre-trained language model or base language model (120) can be any model capable of processing such input, including a transformer-based model, embedding model, sequence model, encoder-only model, decoder-only model, encoder-decoder model, retrieval model, classification model, or another NLP-capable model. The architecture is not limited to a specific model family and can be used with both locally hosted and remotely accessed models.

In embodiments, the bounded recognition mapping provides a technical effect of stabilizing downstream NLP computation by limiting overreaction to low-confidence or low-support quantities while preserving monotone responsiveness when support increases. For example, the mapping can reduce instability associated with heterogeneous native score scales, reduce brittleness from hard thresholds used in candidate filtering and reranking, and improve reliability of context-sensitive interpretation and coherence evaluation without retraining or modifying baseline model parameters, thereby reducing compute and deployment complexity while improving operational robustness of the pipeline.

In embodiments, the base embeddings and raw prediction outputs (130) produced by the pre-trained language model or base language model (120) provide the initial measurable quantities to which the recognition-based mappings are applied. For example, the base embeddings and raw prediction outputs (130) can include vector representations suitable for semantic comparison, positional or sequence-derived relationships suitable for coherence calculations, confidence values suitable for confidence weighting, and relevance values suitable for reranking. In this way, the system (100) uses outputs already produced by conventional NLP infrastructure and applies a common recognition-based weighting posture to those outputs without requiring that the baseline model itself be reformulated around Recognition Science. This permits the disclosed architecture to function as a post-processing framework that is additive to, rather than destructive of, existing language-model pipelines.

The recognition semantic embedding module (140) can receive one or more base embeddings from the base embeddings and raw prediction outputs (130) and can compute recognition-enhanced embeddings by comparing a selected embedding with a context-derived embedding and applying a recognition-derived scale factor to a context-alignment correction. In embodiments, the recognition semantic embedding module (140) improves the handling of lexical ambiguity, semantic drift, and context-sensitive interpretation by modulating the degree to which context influences a selected token or language-unit representation. The output of the recognition semantic embedding module (140) can therefore include modified embeddings, context-aligned embeddings, ambiguity-sensitive representations, or other embedding-level outputs suitable for use by other modules or downstream tasks.

The recognition contextual coherence module (150) can receive embeddings, including in some embodiments outputs of the recognition semantic embedding module (140), and can compute one or more contextual coherence values for a sentence, passage, response, translation, or other text unit. In embodiments, the recognition contextual coherence module (150) computes pairwise or grouped semantic relationships among language units and weights such relationships according to positional distance or another quantity using the recognition coverage function. The resulting coherence outputs can be used to score generated text quality, evaluate discourse continuity, detect topical boundaries, prioritize post-editing, assist in readability analysis, or support other structure-sensitive NLP tasks. Accordingly, the recognition contextual coherence module (150) functions as a semantic-structural evaluator within the broader system (100). The recognition sentiment analysis module (160) can receive sentiment-related values from the base embeddings and raw prediction outputs (130), including a raw sentiment quantity and an associated classifier confidence quantity, and can compute a confidence-weighted sentiment output by applying a recognition-based weighting to the confidence quantity. In embodiments, the recognition sentiment analysis module (160) continuously suppresses low-confidence sentiment predictions relative to higher-confidence sentiment predictions, thereby reducing the overcommitment that can arise when raw classifier labels are consumed without regard to confidence. The output of the recognition sentiment analysis module (160) can be used in moderation systems, review analytics, feedback triage, emotional classification, toxicity handling, or other decision flows in which confidence-proportional scaling is beneficial. The recognition token reranking module (170) can receive candidate-associated values from the base embeddings and raw prediction outputs (130), including relevance scores or transformed relevance scores for tokens, passages, documents, beam hypotheses, answer candidates, or other selectable candidates. The recognition token reranking module (170) can compute recognition-based reranking weights from those relevance quantities and can produce soft-ranked candidate outputs in which all candidates may retain graded influence even if a later stage ultimately selects only one or a small subset. In embodiments, the recognition token reranking module (170) can be used in retrieval-augmented generation, semantic search, beam-search reranking, document ranking, answer selection, and similar ranking-intensive applications. By using continuous recognition-based weighting rather than hard thresholding at the reranking stage, the recognition token reranking module (170) can preserve near-boundary information that might otherwise be discarded.

In some embodiments, one or more outputs from the recognition semantic embedding module (140), the recognition contextual coherence module (150), the recognition sentiment analysis module (160), and the recognition token reranking module (170) can be provided to the combined scoring module (180). The combined scoring module (180) can aggregate multiple module outputs into a single decision-oriented score, ranking quantity, or semantic prediction value. In embodiments, the combined scoring module (180) can combine an alignment-related quantity, a coherence-related quantity, a confidence-weighted sentiment quantity, and a reranking-related quantity using weights derived from the shared recognition-scale constant X_opt. In other embodiments, the combined scoring module (180) may combine fewer than all available inputs, may omit one or more module families, or may be bypassed entirely where a downstream task is to operate directly on outputs of one or more upstream modules. The combined scoring module (180) is therefore optional in some embodiments, but where present it provides a system-level mechanism for integrating multiple recognition-derived signals into a unified decision metric.

The downstream task module (190) can receive outputs from one or more of the recognition semantic embedding module (140), the recognition contextual coherence module (150), the recognition sentiment analysis module (160), the recognition token reranking module (170), and the combined scoring module (180). In embodiments, the downstream task module (190) can implement or support classification, generation, retrieval, semantic search, question answering, summarization, content moderation, document segmentation, machine translation evaluation, named entity handling, dialogue response selection, passage selection, output filtering, or another application-level NLP operation. The downstream task module (190) can produce a final output for presentation to a user, for storage in memory or a database, for transmission to another system, or for further iterative processing within a larger software pipeline.

In embodiments, the modular arrangement shown in FIG. 1 permits selective use of fewer than all illustrated modules. For example, the recognition-based natural language processing system (100) can be configured such that only the recognition semantic embedding module (140) is active, such that only the recognition contextual coherence module (150) is active, such that only the recognition sentiment analysis module (160) is active, such that only the recognition token reranking module (170) is active, or such that any two or more of those modules operate together. In some embodiments, the combined scoring module (180) is omitted and the downstream task module (190) receives outputs directly from one or more of the modules (140), (150), (160), and (170). This modularity is useful both for deployment flexibility and for preserving claim support across method, system, and computer-implemented embodiments of differing scope.

In embodiments, the disclosed workflows share a common inventive concept of applying a bounded recognition coverage mapping parameterized by X_opt=phi/pi to normalize, weight, and modulate nonnegative language-model-derived quantities across different post-processing tasks. By using a common bounded mapping basis, the system can reduce sensitivity to native score-scale differences and hard cutoffs while remaining model-agnostic and without requiring modification of baseline model weights.

In some embodiments, the modules (140), (150), (160), and (170) operate as post-processing layers without modifying the model weights of the pre-trained language model or base language model (120). In such embodiments, the system (100) can be integrated with an already-trained model by receiving its existing outputs and applying the disclosed recognition-based transformations downstream of the original model inference. In other embodiments, a baseline model may itself have been separately fine-tuned or otherwise adapted before use within the system (100), while the recognition-based modules still operate as distinct computational stages relative to that baseline model's inference outputs. Thus, the phrase “post-processing” in this context refers to architectural placement relative to produced outputs and does not exclude the use of a fine-tuned or customized baseline model upstream.

The architecture of FIG. 1 can also be understood as a common-function system in which distinct categories of model-derived quantities are processed using a shared recognition-based weighting logic. More specifically, semantic divergence quantities can be used by the recognition semantic embedding module (140), positional-distance-related quantities can be used by the recognition contextual coherence module (150), confidence quantities can be used by the recognition sentiment analysis module (160), and relevance quantities can be used by the recognition token reranking module (170). Despite the differing operational roles of those quantities, each can be mapped through the same recognition coverage function using the shared constant X_opt. This gives the system (100) a mathematically unified architecture in which multiple subsystem behaviors are grounded in the same bounded and monotone recognition-derived scaling posture. In embodiments, the recognition-based natural language processing system (100) can be implemented as software, firmware, hardware, or any suitable combination thereof. The pre-trained language model or base language model (120) can run on the same processor or device as the modules (140), (150), (160), (170), (180), and (190), or can operate remotely such that the base embeddings and raw prediction outputs (130) are transmitted to another system for recognition-based processing. Likewise, the downstream task module (190) can be co-located with the other modules or can be implemented as an external system receiving recognition-processed outputs through an interface. The figure therefore represents a functional architecture rather than a requirement that all shown components be physically integrated into a single device.

Accordingly, FIG. 1 illustrates a recognition-based natural language processing system (100) in which an input text or query (110) is processed by a pre-trained language model or base language model (120) to generate base embeddings and raw prediction outputs (130), and those outputs are selectively transformed by a recognition semantic embedding module (140), a recognition contextual coherence module (150), a recognition sentiment analysis module (160), a recognition token reranking module (170), and, in some embodiments, a combined scoring module (180), before being consumed by a downstream task module (190). This end-to-end arrangement provides a practical architectural foundation for the more specific workflows, equations, examples, and implementation details described in the sections that follow.

Referring again to FIG. 1 and also to FIG. 6, one fully implementable anchor embodiment can be realized as a combined semantic prediction method executed by the recognition-based natural language processing system (100). In this embodiment, the system (100) receives an input text or query (110) and provides the input text or query (110) to the pre-trained language model or base language model (120). The pre-trained language model or base language model (120) generates base embeddings and raw prediction outputs (130), and the resulting values are supplied to the recognition semantic embedding module (140), the recognition contextual coherence module (150), the recognition sentiment analysis module (160), and the recognition token reranking module (170). Intermediate outputs from those modules are then provided to the combined scoring module (180), which operates according to the combined semantic prediction workflow (600) to generate a final semantic prediction output (680) for delivery to the downstream task module (190). This anchor embodiment provides a concrete “one way to make/use” path because it identifies the incoming data, the operational parameters, the window computation, the transformation actions, the selection logic, and the verification posture within a single end-to-end workflow.

In one implementation, the input text or query (110) is tokenized into a token sequence T=[w_1, w_2, . . . , w_N], and the pre-trained language model or base language model (120) generates a corresponding set of base embeddings E_orig(w_i) for the tokens in the token sequence. In embodiments, the base embeddings and raw prediction outputs (130) can additionally include a raw sentiment score S_raw(T), a classifier confidence value Conf sent(T), and one or more candidate relevance scores r_k associated with candidate tokens, candidate senses, candidate passages, candidate documents, candidate answers, or other selectable outputs. In this anchor embodiment, those quantities are sufficient to drive all four recognition-based module families and the optional combined score pathway. The result is an implementation in which a single input can be transformed into multiple bounded intermediate representations and then into a final decision-oriented output.

In embodiments, at least four operational parameters can be identified for the anchor embodiment. A first operational parameter is a context window size K, which controls the set of neighboring tokens used to compute a context embedding for a selected token. A second operational parameter is distance metric selection, such as cosine distance or Euclidean distance, used by the recognition semantic embedding module (140) when comparing a selected base embedding to a context-derived embedding. A third operational parameter is a candidate-set size k, which determines how many candidate outputs are carried into the reranking or combined-scoring stages. A fourth operational parameter is an optional normalization choice used by the recognition token reranking module (170) when converting raw reranking weights into normalized candidate weights. Additional implementation choices may be used in particular embodiments, but these parameters are sufficient to define a concrete and reproducible operational method for carrying out the disclosed workflow.

In the anchor embodiment, the recognition semantic embedding module (140) first performs a window computation for each selected token w_i. More specifically, a context embedding is computed using the context window size K according to E_context(i)=mean({E_orig(w_j):|i−j|<=K}). Thus, the context embedding for token w_i is based on the base embeddings of tokens lying within the selected positional window around w_i. In the same embodiment, positional separation values can also be computed as D_ij=|i−j| for later use by the recognition contextual coherence module (150). These computations provide the concrete window-based and position-based values required for subsequent recognition-weighted processing. Because the context window size K is explicitly identified and the computations are tied to actual token positions, this stage provides a definite computational mechanism rather than merely an abstract statement that “context” is considered.

After the context embedding E_context(i) has been computed, the recognition semantic embedding module (140) computes a semantic distance d_i between the selected base embedding and the context embedding. In one embodiment, that distance is computed as d_i=dist(E_context(i), E_orig(w_i)), where dist is the selected nonnegative distance metric. A recognition scale factor is then computed as scale_i=d_i/(d_i+X_opt), which is equivalent to applying the recognition coverage function to the semantic distance. The module then generates a recognition-enhanced embedding according to E_rec(w_i)=E_orig(w_i)+scale_i*(E_context(i)−E_orig(w_i)). In this way, the recognition semantic embedding module (140) performs an explicit action on the base embedding by moving the base embedding toward a context-derived embedding in a bounded, distance-sensitive manner. Where semantic distance is small, the correction is correspondingly small. Where semantic distance is larger, a larger but still bounded context-alignment correction is produced.

The recognition-enhanced embeddings E_rec(w_i) are then available for use by the recognition contextual coherence module (150). In one embodiment, the recognition contextual coherence module (150) receives a sentence or text segment and computes a semantic coherence score by aggregating pairwise similarity contributions among recognition-enhanced embeddings. One suitable implementation is C_sem(S)=(1/(N*(N−1)))*sum_{i=1 . . . N}sum_{j=1 . . . N, j !=i}[max(0, CosSim(E_rec(w_i), E_rec(w_j)))*F_cov(|i−j|)]. Under this formulation, a nonnegative similarity contribution is computed for each ordered or unordered token pair, and that contribution is weighted by a positional-distance term F_cov(|i−j). The resulting coherence score is therefore sensitive both to semantic relatedness and to token separation. In embodiments, this provides a concrete and reproducible way to quantify contextual coherence for later use in scoring, ranking, boundary detection, or downstream selection.

In parallel with the coherence computation, the recognition sentiment analysis module (160) can receive a raw sentiment score S_raw(T) and a classifier confidence value Conf sent(T) from the base embeddings and raw prediction outputs (130). The recognition sentiment analysis module (160) then computes a confidence-weighted sentiment intensity according to S_intensity(T)=S_raw(T)*F_cov(Conf_sent(T)). Because F_cov(Conf_sent(T)) is bounded and monotone over nonnegative confidence values, low-confidence sentiment predictions are continuously suppressed relative to higher-confidence predictions rather than being treated by a hard confidence cutoff. This gives the system (100) a concrete mechanism for integrating predictive confidence into sentiment intensity. In embodiments, the resulting sentiment intensity may be provided as the confidence-weighted sentiment input (630) to the combined semantic prediction workflow (600), or may be separately used by the downstream task module (190) in moderation, analytics, feedback triage, or related applications.

Also in parallel, the recognition token reranking module (170) can receive one or more candidate relevance scores r_k associated with candidate outputs. In one embodiment, a reranking weight is computed for each candidate as w_k=F_cov(r_k). Where a raw candidate score is not already nonnegative, a nonnegative transform may first be applied so that the recognition coverage function receives a nonnegative input. In some embodiments, normalized candidate weights can also be computed, for example by dividing each w_k by the sum of the weights over the retained candidate set. The recognition token reranking module (170) can then produce a ranked candidate list, a selected candidate subset, or a selected candidate output. This stage supplies the reranking weight input (640) to the combined semantic prediction workflow (600) and also provides a standalone soft-ranking mechanism for retrieval-augmented generation, beam-search reranking, answer selection, document ranking, or similar tasks.

Referring to FIG. 6, the combined semantic prediction workflow (600) can then receive an alignment score input (610), a coherence score input (620), a confidence-weighted sentiment input (630), and a reranking weight input (640). In one embodiment, the alignment score input (610) is defined in terms of the semantic embedding stage as A(token,C)=1−scale(token,C), where scale(token,C) corresponds to the recognition scale factor computed for a candidate token relative to a relevant context C. A mixture weight generator (650) can derive mixture weights from X_opt by computing Z_mix=1+X_opt+X_opt\hat{ }2+X_opt\hat{ }3, alpha=1/Z_mix, beta=X_opt/Z_mix, gamma=X_opt\hat{ }2/Z_mix, and delta=X_opt\hat{ }3/Z_mix. A combined score computation block (660) can then compute a combined score according to Score(token)=alpha*A(token,C)+beta*C_sem(S)+gamma*F_cov(Conf_sent(T))+delta*w_token. Because each term is bounded and the mixture coefficients are derived from X_opt, the resulting score is bounded and can be compared across candidate outputs even where raw model outputs originated on different native scales.

The candidate comparison or selection stage (670) then applies a decision rule to one or more candidate outputs. In one embodiment, the decision rule is to select the candidate token, candidate sense, candidate passage, candidate answer, or other candidate output associated with the highest combined score. In another embodiment, where the combined score pathway is omitted or not available, the decision rule can be to select the candidate associated with the highest reranking weight w_k. In a further ambiguity-resolution embodiment, the decision rule can prefer the sense candidate with the smallest recognition correction magnitude proxy, such as a value based on d*scale, where smaller correction magnitude indicates stronger native contextual fit. In a document-segmentation embodiment, the decision rule can identify a boundary when the coherence score drops below a running average or other comparison baseline. Thus, the anchor embodiment supports not only one numerical scoring path, but also concrete comparative decision rules that can be directly implemented in software or other computational logic.

The final semantic prediction output (680) can correspond to a selected token, selected word sense, selected passage, selected answer, selected classification result, selected moderation action, selected segmentation boundary, or another downstream-consumable output. The downstream task module (190) can receive that final semantic prediction output (680) and either present it directly, store it, transmit it, or use it as an intermediate value in a larger application pipeline. In embodiments, the final semantic prediction output (680) is not limited to a single discrete label. For example, the output may include a ranked list of candidates, a weighted subset of retrieval results, a confidence-associated action, or a decision package containing both the selected result and one or more intermediate scores used in producing that result.

The anchor embodiment also includes a verification posture. In one embodiment, a semantic accuracy improvement metric can be computed as Delta_A=(A_rec−A_baseline)/A_baseline*100%, where A_rec is an accuracy or task-performance measure obtained using recognition-based processing and A_baseline is the corresponding measure obtained without that processing. In another embodiment, inference latency overhead can be measured by comparing inference time with and without the disclosed recognition-based computations. In another embodiment, coherence separation can be evaluated by comparing coherence scores for coherent text against coherence scores for incoherent text or cross-topic text. In another embodiment, retrieval performance can be evaluated by comparing the relative reranking order of candidate passages before and after recognition-based weighting. These metrics provide concrete verification paths for determining whether the selected implementation is producing the desired operational effects. A decision rule can also be applied at the verification stage. For example, a selected output may be accepted where the combined score exceeds a threshold or where the selected candidate's score exceeds the next-best candidate by at least a margin. A selected output may be escalated for fallback handling where the combined score fails to exceed a threshold, where multiple candidates remain within a predefined closeness interval, or where coherence or confidence values indicate elevated uncertainty. Likewise, a recognition-based configuration may be retained in deployment where the semantic accuracy improvement metric exceeds a baseline-improvement criterion while latency remains below a selected overhead criterion. These verification and acceptance rules make the embodiment operationally complete by specifying not only how scores are generated, but also how those scores are used to accept, reject, escalate, or compare outputs.

In one embodiment, the system applies an acceptance rule to a selected candidate output based on at least one of: (i) whether a combined score exceeds an acceptance threshold tau, (ii) whether a score margin between a best candidate and a next-best candidate exceeds a margin m, or (iii) whether multiple candidates fall within a closeness interval epsilon indicating ambiguity. In one example, tau, m, and epsilon are selected per deployment to balance precision and recall, and the system escalates to a fallback handling mode when the acceptance rule is not satisfied, including requesting additional context, expanding a candidate set, or deferring the output for further analysis.

In some embodiments, the anchor embodiment is implemented without modifying stored weights of the pre-trained language model or base language model (120). In such embodiments, the recognition semantic embedding module (140), recognition contextual coherence module (150), recognition sentiment analysis module (160), recognition token reranking module (170), and combined scoring module (180) operate as post-processing stages applied to outputs already generated by the base language model (120). In other embodiments, the same anchor embodiment can be used with a separately fine-tuned baseline model, provided the disclosed recognition-based operations remain distinct computational stages applied to produced outputs. This preserves the disclosed model-agnostic architecture while still supplying a complete and reproducible implementation path.

Accordingly, the anchor embodiment shown by FIG. 1 and FIG. 6 provides a fully implementable combined semantic prediction method in which the system (100) receives an input text or query (110), generates base embeddings and raw prediction outputs (130) using the pre-trained language model or base language model (120), computes recognition-enhanced embeddings through the recognition semantic embedding module (140), computes a coherence score through the recognition contextual coherence module (150), computes a confidence-weighted sentiment intensity through the recognition sentiment analysis module (160), computes candidate reranking weights through the recognition token reranking module (170), and optionally combines those outputs in the combined scoring module (180) to generate a final semantic prediction output (680) via the workflow (600). This embodiment identifies concrete inputs, explicit computational parameters, a context-window computation, definite transformation actions, candidate-selection rules, and verification metrics with decision logic, thereby supplying a practical implementation anchor for the disclosed invention.

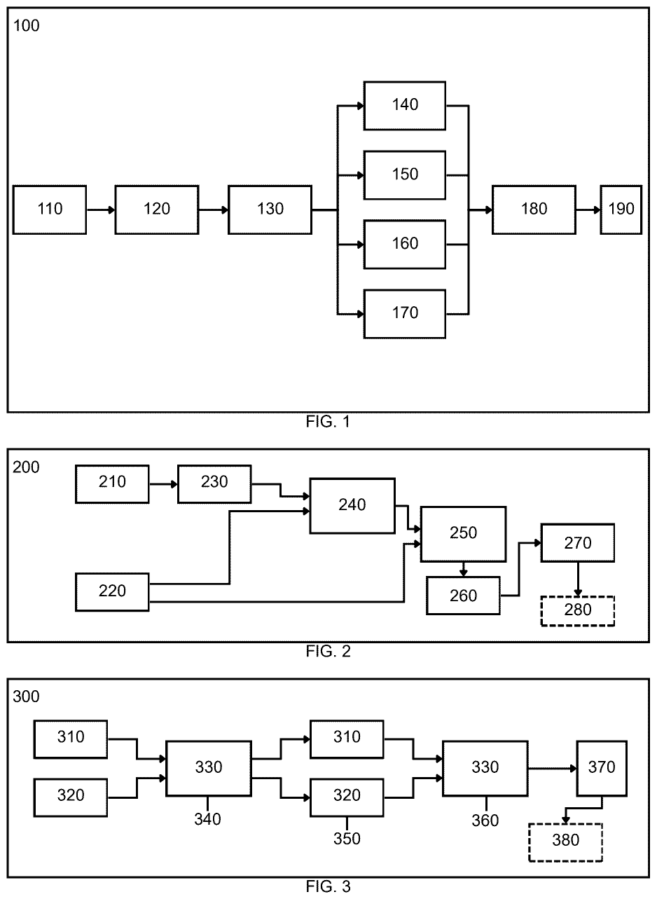

Referring to FIG. 2, a recognition semantic embedding workflow (200) can receive a token sequence (210) and a base embedding set (220). In embodiments, the token sequence (210) comprises an ordered series of words, subwords, symbols, punctuation-bearing units, byte-pair encoded units, sentence pieces, or other language-model units derived from an input text, query, prompt, response, document, dialogue turn, passage, or other natural-language-bearing content. The base embedding set (220) comprises vector representations corresponding to the members of the token sequence (210), and those vector representations can be generated by, retrieved from, or otherwise received from a pre-trained language model or base language model, including a transformer model, embedding model, encoder, decoder, encoder-decoder model, retrieval model, classification model, or other natural language processing model. In embodiments, the recognition semantic embedding workflow (200) operates on embeddings already produced by such a model and therefore functions as a post-processing stage that augments representational quality without requiring modification of the underlying model weights.

In one embodiment, the recognition semantic embedding workflow (200) processes the token sequence (210) on a token-by-token basis. For each selected token in the token sequence (210), a context window (230) is defined, and a context embedding generator (240) computes a context embedding using embeddings associated with tokens that fall within that context window (230). The semantic distance computation stage (250) then computes a semantic distance between the selected token's base embedding and the corresponding context embedding. A recognition scale factor computation stage (260) computes a recognition scale factor from that semantic distance using the recognition coverage function. A recognition-enhanced embedding output (270) is then generated by applying the recognition scale factor to a context-alignment correction based on the difference between the selected base embedding and the context embedding. In some embodiments, a sense-selection or ambiguity-resolution output (280) can be produced from the recognition-enhanced embedding output (270), such as where multiple candidate meanings, labels, or senses are evaluated relative to contextual fit.

The token sequence (210) need not be limited to a single sentence and can represent any sequence length supported by the underlying model and implementation. In embodiments, the token sequence (210) may include a full prompt, a retrieved passage, a sentence within a larger document, a dialogue exchange, a translation candidate, or a generated output. Likewise, the base embedding set (220) need not be limited to one embedding per visible surface word. The base embedding set (220) can include subword-level embeddings, contextual token embeddings, phrase-level embeddings, pooled embeddings, or other vector representations associated with the token sequence (210). In embodiments in which multiple embedding representations are available for a given language unit, one selected representation can be treated as the base embedding for purposes of the recognition semantic embedding workflow (200), or multiple representations can be combined upstream before entry into the workflow (200).

The context window (230) defines the contextual neighborhood used to compute the context embedding for a selected token. In one embodiment, the context window (230) is a fixed positional window of size K around a selected token w_i, such that tokens satisfying |i−j|<=K are included in the window. In such an embodiment, the context embedding generator (240) can compute the context embedding as E_context(i)=mean({E_orig(w_j):|i−j|<=K}). This provides a concrete and reproducible mechanism for computing a local contextual reference against which the selected base embedding can be compared. In embodiments, the context window size K is a configurable operational parameter that may be selected according to sequence length, latency targets, semantic granularity, model architecture, or application type. In other embodiments, the context window (230) can be adaptive rather than fixed. For example, the context window (230) can expand or contract based on punctuation, sentence boundaries, clause boundaries, discourse markers, speaker turns, retrieved context limits, token confidence properties, semantic density, or another criterion. In some embodiments, the context window (230) is sentence-bounded, such that the context embedding generator (240) uses only tokens within the same sentence as the selected token. In other embodiments, the context window (230) is conversation-history bounded, such that the selected token is interpreted in light of tokens appearing within one or more preceding dialogue turns. In still further embodiments, the context window (230) can be paragraph-bounded, retrieval-context bounded, or otherwise restricted by a predefined textual unit or a dynamically selected semantic region. These fallback embodiments preserve the same core recognition-semantic mechanism while allowing implementation-specific control over what constitutes relevant context for a selected token.

The context embedding generator (240) can compute the context embedding in different ways while remaining within the disclosed recognition semantic embedding framework. In one embodiment, the context embedding is a simple arithmetic mean of the embeddings included within the context window (230). In another embodiment, the context embedding is a weighted mean, where tokens within the context window (230) are assigned different aggregation weights based on position, recency, syntactic relation, confidence, attention-derived importance, retrieval importance, punctuation structure, discourse role, or another weighting criterion. In still other embodiments, the context embedding generator (240) can apply pooling, averaging over a subset of context tokens, or another aggregate vector-construction method so long as the output is a context-derived embedding suitable for comparison with a selected base embedding. Thus, the context embedding generator (240) is not limited to a single averaging rule, although the simple mean embodiment remains a clear baseline implementation.

Once the context embedding has been generated by the context embedding generator (240), the semantic distance computation stage (250) computes a nonnegative semantic distance between the selected base embedding and the context embedding. In one embodiment, this is expressed as d_i=dist(E_context(i), E_orig(w_i)), where dist is a selected nonnegative distance metric and E_orig(w_i) is the base embedding of the selected token. In one embodiment, the semantic distance computation stage (250) uses Euclidean distance. In another embodiment, the semantic distance computation stage (250) uses cosine distance. In still other embodiments, another nonnegative divergence or separation metric can be used, provided it is suitable for measuring the degree to which the selected token representation is aligned with or divergent from its local or broader context. Where a native similarity value is initially produced instead of a distance value, the semantic distance computation stage (250) can convert that value into a nonnegative distance-like quantity before passing it to the recognition scale factor computation stage (260). The semantic distance computed by the semantic distance computation stage (250) represents the degree of contextual divergence between a selected token's original representation and the embedding that represents its surrounding context. In embodiments, this quantity provides a principled indicator of how much context-sensitive correction should be applied to the selected token embedding. Where the selected token is already well aligned with its context, the semantic distance can be small. Where the selected token has an ambiguous, shifted, or context-sensitive meaning that is not well captured by the original representation alone, the semantic distance can be larger. This distinction is important because the recognition semantic embedding workflow (200) does not apply a uniform correction to every token. Instead, the magnitude of the correction is determined from the measured contextual divergence itself.

The recognition scale factor computation stage (260) computes a recognition scale factor from the semantic distance produced by the semantic distance computation stage (250). In one embodiment, the recognition scale factor is computed as scale_i=d_i/(d_i+X_opt), which is equivalent to applying the recognition coverage function to the semantic distance d_i. In embodiments, this recognition scale factor is bounded and monotone for nonnegative semantic distances. As a result, a token whose embedding is closely aligned with context receives little or no recognition-based correction, whereas a token that is more context-divergent receives a stronger recognition-based correction. The recognition scale factor computation stage (260) therefore provides the adaptive control quantity that determines the degree of representational update applied at the next stage.

A recognition-enhanced embedding output (270) is then generated by applying the recognition scale factor to a correction term between the selected base embedding and the context embedding. In one embodiment, the recognition-enhanced embedding output (270) is computed according to E_rec(w_i)=E_orig(w_i)+scale_i*(E_context(i)−E_orig(w_i)). Under this formulation, the selected base embedding is moved toward the context embedding by an amount determined by the recognition scale factor. If d_i=0, then scale_i=0, and the resulting recognition-enhanced embedding is the same as the original base embedding, such that no modification occurs. As d_i increases, the recognition scale factor increases, and the selected base embedding is drawn more strongly toward the context embedding, but in a bounded manner. This produces a context-modulated embedding sequence that reflects contextual meaning more directly than the original embedding sequence while preserving controlled and continuous update behavior.

In embodiments, the recognition-enhanced embedding output (270) can be produced for each token in the token sequence (210), thereby generating a full sequence of recognition-enhanced embeddings {E_rec(w_i)}. In other embodiments, only a selected subset of tokens is processed, such as content-bearing words, ambiguous tokens, named entities, classification-relevant spans, or tokens associated with downstream uncertainty. In still other embodiments, the recognition-enhanced embedding output (270) can be generated iteratively or selectively, such as during beam-search evaluation, answer-candidate evaluation, ambiguity detection, or retrieval-context integration. The workflow (200) therefore supports both whole-sequence processing and targeted token-level refinement depending on implementation needs.

One useful property of the recognition semantic embedding workflow (200) is that the contextual update is bounded by the recognition scale factor. In embodiments, this means that the context-alignment correction does not grow without control even when a token is substantially divergent from its surrounding context. Instead, the adjustment remains governed by the bounded recognition mapping. In another useful property, the recognition scale factor increases monotonically with semantic distance, such that more context-divergent tokens receive stronger correction than more context-aligned tokens. Together, these properties provide a mathematically disciplined approach to context-sensitive embedding refinement that is particularly suitable for language units whose interpretation depends heavily on surrounding text.

The recognition-enhanced embedding output (270) can be used directly in downstream natural language processing operations. In some embodiments, the recognition-enhanced embedding output (270) is consumed by a classifier to improve context-aware label selection. In some embodiments, the recognition-enhanced embedding output (270) is used in semantic search or retrieval pipelines to improve matching between a query and candidate passages. In some embodiments, the recognition-enhanced embedding output (270) is used in question answering, summarization, document analysis, or machine translation evaluation. In some embodiments, the recognition-enhanced embedding output (270) is supplied to the recognition contextual coherence workflow for computation of sentence-level or passage-level coherence. In this way, the workflow (200) is both independently useful and useful as an upstream stage for other recognition-based modules.

In one important embodiment, the recognition semantic embedding workflow (200) is used for ambiguity-sensitive interpretation of a token that may correspond to multiple candidate senses or semantic roles. In such embodiments, the recognition-enhanced embedding output (270) can be compared against candidate sense embeddings, candidate label embeddings, or candidate semantic templates to determine which candidate best fits the surrounding context. In one implementation, the sense-selection or ambiguity-resolution output (280) can prefer the candidate that requires the smallest recognition correction or smallest recognition correction magnitude proxy. For example, where two candidate senses are under consideration, a correction magnitude proxy based on d*scale can be used to indicate which candidate is more naturally aligned with the context. A candidate associated with a smaller recognition correction magnitude can be preferred because it indicates a closer initial semantic fit to the surrounding context. This ambiguity-resolution posture is useful for polysemous words, named entities, domain-shifting terms, or tokens whose meaning depends strongly on discourse context. For example, where a token can refer to a company or a fruit, or a financial institution or a river edge, the workflow (200) can compute context-based corrections for candidate interpretations and select the candidate that is most compatible with the actual context in which the token appears. The sense-selection or ambiguity-resolution output (280) can therefore provide a selected sense, selected semantic label, selected disambiguated embedding, or another context-resolved output suitable for downstream use. In embodiments, the sense-selection or ambiguity-resolution output (280) can be supplied to a classifier, a search system, a question-answering system, or a generation system to reduce ambiguity-induced errors.

The workflow (200) can also support classification-oriented embodiments. In one such embodiment, the recognition-enhanced embedding output (270) is used in place of, or in addition to, the base embedding set (220) when computing classification logits, label similarity values, or downstream feature vectors. This can improve context sensitivity in sentiment classification, topic classification, intent classification, moderation, named entity recognition, or relation extraction. In another embodiment, the recognition-enhanced embedding output (270) is used to improve retrieval conditioning or passage ranking by providing better context-aware representations of a query or response. In another embodiment, the workflow (200) supports summarization by refining token-level representations before sentence scoring, content selection, or compression logic is applied. These variations do not alter the core operation of the workflow (200), but demonstrate the breadth of practical NLP settings in which the disclosed recognition-semantic mechanism can be used.

In embodiments, the recognition semantic embedding workflow (200) wraps existing embedding layers or existing model outputs rather than replacing them. For example, the base embedding set (220) can come from an embedding layer of a transformer model, from an external embedding model, from a stored retrieval representation, or from another language-representation source, and the workflow (200) can then generate recognition-enhanced embeddings as a further processing step. This means that the workflow (200) can be integrated into existing NLP stacks without retraining the underlying model. In some embodiments, no retraining is required at all, and the workflow (200) operates entirely at inference time. In other embodiments, the same workflow can be used with a fine-tuned upstream model, while still preserving the architectural separation between the underlying model and the recognition-semantic post-processing stage.

In embodiments, the computational burden associated with the recognition semantic embedding workflow (200) remains modest because the workflow principally involves context aggregation, distance computation, recognition-scale computation, and vector update operations. The semantic distance computation stage (250) performs a selected distance evaluation, and the recognition scale factor computation stage (260) performs an evaluation of the recognition mapping using the shared constant X_opt. The recognition-enhanced embedding output (270) is then generated through vector arithmetic involving the base embedding and the context embedding. These operations are well suited to implementation on general-purpose processors, graphics processing units, tensor accelerators, or other computing hardware and can be applied sequence-wide or selectively depending on latency and throughput targets.

The workflow (200) is also compatible with different deployment topologies. In some embodiments, the token sequence (210) and base embedding set (220) are produced and consumed on the same machine. In other embodiments, the base embedding set (220) is generated by a remote service and delivered to a local instance of the workflow (200) for context-sensitive enhancement. In still other embodiments, the context window (230), context embedding generator (240), semantic distance computation stage (250), recognition scale factor computation stage (260), and recognition-enhanced embedding output (270) are distributed across multiple processing nodes or software services. Such variations do not change the substance of the disclosed method and remain within the recognition semantic embedding framework so long as the workflow performs the disclosed context-based embedding refinement. Accordingly, FIG. 2 illustrates a recognition semantic embedding workflow (200) in which a token sequence (210) and a base embedding set (220) are processed using a context window (230), a context embedding generator (240), a semantic distance computation stage (250), and a recognition scale factor computation stage (260) to produce a recognition-enhanced embedding output (270), and, in some embodiments, a sense-selection or ambiguity-resolution output (280). This workflow provides a concrete, bounded, and context-sensitive mechanism for improving semantic representations in natural language processing systems while preserving compatibility with existing embedding architectures and downstream NLP tasks.

Referring to FIG. 3, a recognition contextual coherence workflow (300) can receive a sentence or text segment (310) together with an enhanced embedding input set (320). In embodiments, the sentence or text segment (310) can be a sentence, utterance, clause sequence, paragraph, generated response, translation output, retrieved passage, summary candidate, dialogue turn, or another text unit for which semantic continuity or discourse-level fit is to be evaluated. The enhanced embedding input set (320) can include recognition-enhanced embeddings produced by the recognition semantic embedding workflow, although in some embodiments the workflow (300) can also operate on base embeddings where recognition-enhanced embeddings are unavailable, omitted, or not required for a given implementation. The recognition contextual coherence workflow (300) is therefore configured to transform embedding relationships within a text unit into a scalar coherence quantity that can be used for evaluation, segmentation, filtering, ranking, or other downstream decision-making.

In one embodiment, the recognition contextual coherence workflow (300) receives a text unit containing N tokens and an associated embedding sequence, and a token-pair generator (330) enumerates token pairs drawn from that text unit. The token-pair generator (330) can generate all ordered pairs (i, j) such that i !=j, all unordered pairs, or another selected subset of token-pair relationships depending on implementation choice. For each generated token pair, a cosine similarity computation stage (340) computes a similarity value between the corresponding embeddings, and a positional distance computation stage (350) computes a positional distance between the token positions. A weighted coherence term computation stage (360) then combines a nonnegative similarity quantity with a coverage-based positional weighting to generate one or more weighted coherence terms. Those weighted coherence terms are aggregated to generate a coherence score output (370), and a coherence-based decision output (380) can then be produced for segmentation, ranking, filtering, readability assessment, discourse analysis, or another downstream task.

In one embodiment, the enhanced embedding input set (320) is given by {E_rec(w_i)} for a text unit S containing N tokens. The token-pair generator (330) generates token pairs (i, j) with i !=j. For each such pair, the cosine similarity computation stage (340) computes CosSim_ij=E_rec(w_i)·E_rec(w_j)/(∥E_rec(w_i)∥*∥E_rec(w_j)∥). Because raw cosine similarity may be negative for semantically misaligned token pairs, the workflow (300) can use a nonnegative similarity quantity by applying positive-part handling, such as CosSim_plus_ij=max(0, CosSim_ij). In this way, negative similarity values do not contribute negative coherence mass to the aggregate score. Instead, semantically aligned pairs contribute positively, while semantically opposed or weakly aligned pairs contribute less or nothing, depending on the embodiment.

The positional distance computation stage (350) computes a positional separation quantity for the token pair. In one embodiment, that quantity is D_ij=i−j|, which measures the absolute position difference between token i and token j in the sentence or text segment (310). The positional distance computation stage (350) can therefore determine whether the token pair is adjacent, moderately separated, or long-range. In the disclosed workflow, this distance value is not discarded or treated merely as bookkeeping. Instead, it is used as an input to a recognition-based positional weighting. Accordingly, the recognition contextual coherence workflow (300) is sensitive not only to semantic similarity between embeddings, but also to where the corresponding language units occur relative to one another within the text.

The weighted coherence term computation stage (360) generates a weighted coherence contribution for each token pair by combining the nonnegative similarity value with a recognition-based positional weighting. In one embodiment, the weighted coherence term is given by term_ij=max(0, CosSim(E_rec(w_i), E_rec(w_j)))*F_cov(|i−j). Thus, each pairwise term is determined by both semantic compatibility and positional separation. The use of F_cov(|i−j|) causes the contribution of a token pair to vary according to its position distance under the same bounded recognition mapping used elsewhere in the disclosed system. Because the coverage function is bounded and monotone for nonnegative inputs, the positional weighting remains continuous and finite across all valid pair distances.

After individual pairwise terms have been computed, the coherence score output (370) can be generated by aggregating the weighted coherence terms. In one embodiment, the coherence score output (370) is given by C_sem(S)=(1/(N*(N−1)))*sum term_ij, where the sum is taken over the generated token pairs for the text unit S. In another equivalent embodiment, the coherence score output (370) can be written more explicitly as C_sem(S)=(1/(N*(N−1)))*sum_{i=1 . . . N}sum_{j=1 . . . N, j !=i}[max(0, CosSim(E_rec(w_i), E_rec(w_j)))*F_cov(|i−j|)]. This produces a scalar coherence quantity that summarizes the semantic and positional structure of the text unit. In embodiments, the resulting coherence score output (370) is bounded because each pairwise term is itself bounded by the nonnegative cosine similarity factor and the bounded recognition coverage factor.

The positive cosine handling used by the cosine similarity computation stage (340) is useful because coherence is intended here as a measure of meaningful semantic fit or continuity rather than as a signed polarity measure. Where two token embeddings are strongly compatible, the pair contributes more to the coherence score output (370). Where two token embeddings are weakly related, the contribution is smaller. Where two token embeddings are negatively aligned, the contribution can be clipped to zero rather than allowing a negative quantity to dominate the aggregate measure. This treatment helps keep the coherence score output (370) interpretable as a scalar quantity that increases with semantically supportive structure and decreases when a text unit lacks such structure.

In embodiments, the positional weighting applied at the weighted coherence term computation stage (360) is particularly useful for discourse-sensitive text evaluation because it allows the workflow (300) to distinguish between local adjacency effects and longer-range semantic dependencies. Adjacent tokens often share immediate grammatical or collocational relationships, but longer-range token relationships can carry substantial information about whether a sentence, passage, or response is topically and semantically coherent across its full span. By using F_cov(D_ij) as the positional weighting term, the workflow (300) gives a principled and continuous positional treatment rather than assigning every pair equal weight or relying entirely on a hard cutoff. This makes the workflow (300) suitable for applications in which discourse continuity, topic consistency, and sentence-level or passage-level fit are important.

The token-pair generator (330) need not generate every possible pair in every embodiment. In one embodiment, all token pairs are generated so that the coherence score output (370) reflects the full pairwise structure of the sentence or text segment (310). In another embodiment, only a subset of token pairs is generated, such as token pairs within a maximum window, token pairs associated with content-bearing words, token pairs crossing sentence clauses, token pairs involving named entities, or token pairs sampled according to a computational budget. In another embodiment, the token-pair generator (330) can exclude stop words, punctuation-only tokens, or other low-information units before generating the pair set. These alternatives permit a tradeoff between completeness and computational efficiency while preserving the core recognition contextual coherence logic.

Similarly, the enhanced embedding input set (320) can vary by embodiment. In one embodiment, the enhanced embedding input set (320) comprises recognition-enhanced embeddings generated by the recognition semantic embedding workflow, and the recognition contextual coherence workflow (300) thereby evaluates coherence using context-sensitive token representations. In another embodiment, where the recognition semantic embedding workflow has not been applied or where a simpler implementation is preferred, the enhanced embedding input set (320) can instead comprise base embeddings. In such an embodiment, the same token-pair generation, similarity computation, positional distance computation, weighted-term computation, and score aggregation can still be applied. The workflow (300) therefore supports both a fully integrated mode in which recognition-enhanced embeddings are used and a fallback mode in which base embeddings serve as the coherence-evaluation inputs.

The aggregation used to produce the coherence score output (370) can also vary. In one embodiment, the coherence score output (370) is a normalized average over all generated token-pair terms, as shown above. In another embodiment, the coherence score output (370) is a weighted average in which certain token-pair classes receive additional aggregation emphasis, such as pairs involving content words, entities, or sentence-boundary-spanning terms. In another embodiment, the aggregation can be performed per sentence, per clause, per paragraph, or per selected discourse region before a higher-level coherence score is computed. These variations do not alter the central mechanism by which pairwise semantic fit is combined with recognition-based positional weighting to produce a scalar coherence quantity.

The coherence score output (370) can be used directly in downstream natural language processing tasks. In one embodiment, the coherence score output (370) is used for quality scoring of generated text, such as chatbot responses, summaries, translations, or generated explanations. In another embodiment, the coherence score output (370) is used for document segmentation, where changes in coherence help identify topic shifts, discourse boundaries, or transitions between semantically distinct regions. In another embodiment, the coherence score output (370) is used in readability assessment or discourse structure analysis, such as determining whether a text flows logically across its internal components. In yet another embodiment, the coherence score output (370) is used as an input to a broader scoring or ranking system, including the combined semantic prediction workflow disclosed elsewhere in the application.

The coherence-based decision output (380) can be produced in various ways depending on application needs. In one embodiment, the coherence-based decision output (380) is a binary or multiclass decision indicating whether a text unit is sufficiently coherent for acceptance, publication, routing, or further processing. In another embodiment, the coherence-based decision output (380) is a segmentation marker indicating that a boundary should be inserted when the coherence score output (370) falls below a running average, comparison baseline, or threshold. In another embodiment, the coherence-based decision output (380) is a ranking signal used to prioritize more coherent outputs over less coherent outputs. In another embodiment, the coherence-based decision output (380) is a filter signal used to suppress low-coherence generated answers, low-coherence retrieval candidates, or low-coherence translation candidates before those results are shown to a user or passed to another system.

One useful implementation of the coherence-based decision output (380) arises in topic-shift detection. In such an embodiment, the workflow (300) is applied to consecutive text regions, and a decision rule compares coherence scores across those regions or against a running coherence baseline. Where the coherence score output (370) for a new region drops sufficiently relative to the prior region or to the running average, the coherence-based decision output (380) can indicate a likely topical transition. This is useful for segmenting long documents, transcripts, or multi-turn dialogues into semantically coherent sections. In another implementation, a generated response can be rejected or deprioritized if its coherence score output (370) falls below that of alternative candidates, thereby providing a practical coherence-sensitive output quality filter. The workflow (300) is also well suited to machine-generated text evaluation. In one embodiment, multiple candidate responses produced by a generation system are each processed by the recognition contextual coherence workflow (300), and the coherence score output (370) is used to compare them. A candidate response exhibiting stronger long-range semantic continuity across its token sequence can receive a higher coherence score output (370) and can therefore be preferred. In another embodiment, the coherence score output (370) is combined with relevance, sentiment, or alignment measures in a later scoring stage. These embodiments allow the workflow (300) to act as a structurally informed evaluator of text quality rather than merely as an auxiliary descriptive statistic.

In embodiments, the recognition contextual coherence workflow (300) can be computed with modest additional overhead because the main operations are pair generation, cosine similarity computation, positional distance computation, coverage-function evaluation, and aggregation. On high-throughput hardware, such as graphics processing units or tensor accelerators, these operations can be vectorized across many token pairs. In lower-latency or constrained embodiments, pair generation can be restricted to a subset of token pairs to reduce computation. Thus, the workflow (300) supports both full-resolution and reduced-resolution implementations while preserving its central recognition-weighted coherence structure.

The recognition contextual coherence workflow (300) can be integrated into existing NLP architectures without retraining the underlying language model. Where the enhanced embedding input set (320) or fallback base embeddings are already available, the workflow (300) can be invoked as a post-processing stage to generate the coherence score output (370) and, where desired, the coherence-based decision output (380). In some embodiments, the workflow (300) is executed immediately after embedding generation. In other embodiments, it is executed only for selected outputs, such as candidate responses, retrieved passages, or text spans flagged for quality review. This flexibility allows the workflow (300) to be deployed in interactive systems, batch analysis systems, retrieval systems, translation systems, moderation systems, or content-quality systems without requiring wholesale redesign of the underlying NLP pipeline.

Accordingly, FIG. 3 illustrates a recognition contextual coherence workflow (300) in which a sentence or text segment (310) and an enhanced embedding input set (320) are processed using a token-pair generator (330), a cosine similarity computation stage (340), a positional distance computation stage (350), and a weighted coherence term computation stage (360) to generate a coherence score output (370) and, in some embodiments, a coherence-based decision output (380). This workflow provides a concrete and bounded mechanism for converting embedding relationships within a text unit into a scalar coherence measure that can be used for output quality scoring, segmentation, readability assessment, discourse analysis, filtering, ranking, or related natural language processing operations.

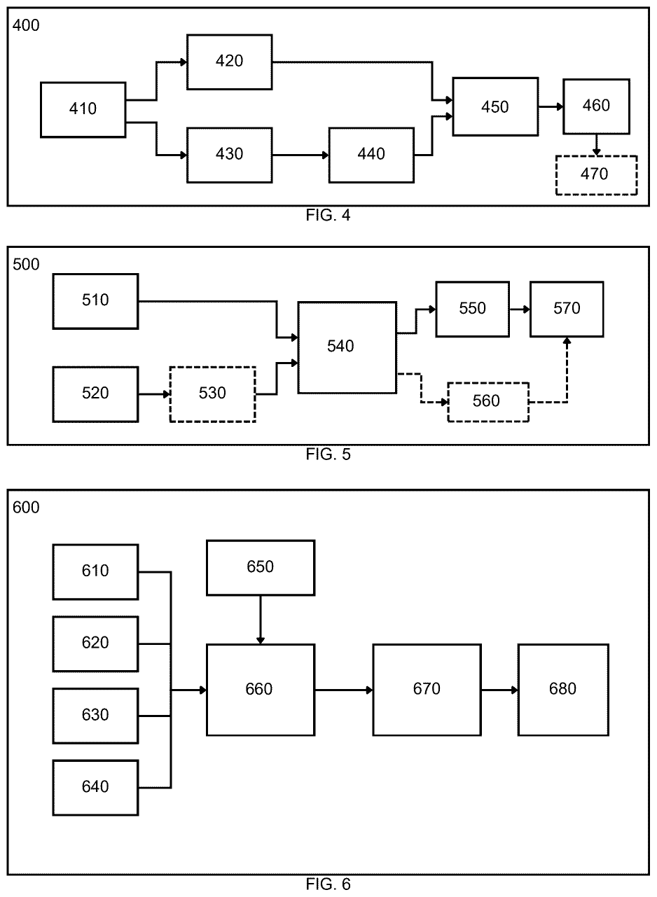

Referring to FIG. 4, a recognition sentiment analysis workflow (400) can receive a text input for sentiment analysis (410), a raw sentiment score (420), and a classifier confidence (430). In embodiments, the text input for sentiment analysis (410) can be a sentence, review, message, dialogue turn, post, document segment, retrieved passage, generated response, transcription segment, or other language-bearing unit for which a sentiment-related interpretation is to be produced. The raw sentiment score (420) can be generated by a baseline classifier, language model, moderation model, sentiment model, or other NLP component capable of assigning a sentiment-related output to the text input for sentiment analysis (410). The classifier confidence (430) can represent the strength, certainty, posterior support, or reliability associated with that raw sentiment score (420). The recognition sentiment analysis workflow (400) is therefore arranged to convert a raw sentiment prediction and an associated confidence quantity into a recognition-weighted sentiment output that reflects both polarity and predictive certainty.

In one embodiment, the raw sentiment score (420) is a scalar quantity S_raw(T) associated with a text unit T, and the classifier confidence (430) is a nonnegative quantity Conf_sent(T) associated with that same text unit. A recognition coverage weighting stage (440) applies the recognition coverage function to the classifier confidence (430), and a sentiment intensity computation stage (450) computes a weighted sentiment quantity according to S_intensity(T)=S_raw(T)*F_cov(Conf_sent(T)). A weighted sentiment output (460) is then produced and can be provided to a moderation or analytics decision output (470). Under this arrangement, the sentiment intensity computation stage (450) does not merely pass through the raw sentiment score (420). Instead, it scales the raw sentiment score (420) according to a bounded recognition-derived weighting determined from the classifier confidence (430).

The raw sentiment score (420) can take different forms in different embodiments. In one embodiment, the raw sentiment score (420) is a signed scalar whose sign indicates polarity and whose magnitude indicates intensity. In another embodiment, the raw sentiment score (420) is a binary or ternary sentiment output that has been converted into a scalar quantity suitable for weighting. In another embodiment, the raw sentiment score (420) corresponds to a toxicity score, moderation-risk score, emotional-intensity score, approval tendency, review-quality score, or other interpretive output produced by a baseline classifier. Thus, although the workflow (400) is referred to herein as recognition sentiment analysis, the same confidence-weighted recognition mechanism can be applied to analogous text-classification outputs in which a classifier produces a value and an associated confidence quantity.

The classifier confidence (430) can also take different forms depending on the source model. In one embodiment, the classifier confidence (430) is a posterior probability or probability-derived confidence value. In another embodiment, the classifier confidence (430) is derived from a softmax output, a calibrated confidence output, a confidence head, an ensemble agreement quantity, or another explicit certainty measure produced by the underlying classifier. In another embodiment, the classifier confidence (430) is derived from a margin, logit difference, or another internal model quantity that is transformed into a nonnegative confidence value before use by the recognition coverage weighting stage (440). Thus, the workflow (400) is not limited to classifiers that natively expose a particular kind of confidence score, so long as a usable nonnegative confidence quantity can be obtained.

The recognition coverage weighting stage (440) computes a recognition-derived weighting factor from the classifier confidence (430). In one embodiment, where the classifier confidence is given by Conf sent(T), the resulting weighting factor is F_cov(Conf_sent(T))=Conf sent(T)/(Conf_sent(T)+X_opt). Because the recognition coverage function is bounded and monotone for nonnegative inputs, the weighting factor increases continuously as the classifier confidence (430) increases, but remains finite and controlled. As a result, the workflow (400) does not require a hard threshold to distinguish “trusted” from “untrusted” sentiment outputs at the weighting stage itself. Instead, confidence sensitivity is incorporated directly into the magnitude of the weighted sentiment value.

The sentiment intensity computation stage (450) then combines the raw sentiment score (420) with the recognition-derived weighting factor to produce the weighted sentiment output (460). In one embodiment, this is performed according to S_intensity(T)=S_raw(T)*F_cov(Conf_sent(T)). In this embodiment, the sign of the raw sentiment score (420), where applicable, is preserved, while the magnitude of the raw sentiment score (420) is scaled according to the confidence-derived recognition weighting. Thus, low-confidence predictions are reduced in magnitude relative to higher-confidence predictions. If the classifier confidence (430) is zero, or approximately zero, the weighted sentiment output (460) can be reduced to zero or toward zero. As the classifier confidence (430) increases, the weighted sentiment output (460) can preserve a larger portion of the raw sentiment score (420). This produces a confidence-sensitive sentiment quantity that is more conservative where model certainty is low and more expressive where model certainty is higher.

One useful feature of the workflow (400) is that it treats confidence as a continuous scaling variable rather than as a binary gate. In conventional systems, a sentiment label may be accepted so long as a confidence threshold is exceeded, even if the underlying confidence is only slightly above that threshold, while a nearly identical prediction slightly below the threshold may be rejected outright. By contrast, the recognition sentiment analysis workflow (400) scales the raw sentiment score (420) continuously through the recognition coverage weighting stage (440), thereby preserving relative differences among low-confidence, medium-confidence, and high-confidence predictions. This can be particularly useful where downstream systems benefit from graded certainty rather than abrupt confidence-based acceptance or rejection.

In one embodiment, the text input for sentiment analysis (410) is a product review or customer feedback item, the raw sentiment score (420) reflects positive or negative sentiment intensity, and the classifier confidence (430) reflects model certainty regarding that polarity assignment. The weighted sentiment output (460) can then be used to rank reviews, identify strongly supported negative feedback, or suppress marginally supported classifications. In another embodiment, the text input for sentiment analysis (410) is a social-media message, comment, or dialogue segment, and the moderation or analytics decision output (470) is used to determine whether the text should be flagged for additional review, automatically routed to another system, or logged with a confidence-sensitive severity value. In another embodiment, the text input for sentiment analysis (410) is a generated response or retrieved text unit, and the weighted sentiment output (460) is used as one factor in a broader quality or policy analysis pipeline. The moderation or analytics decision output (470) can be produced in multiple ways. In one embodiment, the moderation or analytics decision output (470) is a binary moderation decision indicating whether the text input for sentiment analysis (410) should be flagged, blocked, routed, or escalated. In another embodiment, the moderation or analytics decision output (470) is a ranking signal used to prioritize items for review based on confidence-weighted severity or intensity. In another embodiment, the moderation or analytics decision output (470) is a reporting quantity used in dashboards, monitoring systems, or longitudinal analysis of sentiment-bearing content. In another embodiment, the moderation or analytics decision output (470) is a control signal that determines whether a downstream action should be automatically executed or whether human review is required. These embodiments illustrate that the workflow (400) can be used not only to refine sentiment values themselves, but also to support operational decisions that depend on both sentiment and certainty.

The workflow (400) is not limited to binary positive-versus-negative sentiment. In one embodiment, the raw sentiment score (420) represents multiclass sentiment or emotion information, and the recognition sentiment analysis workflow (400) is applied to one or more class-specific scalar values. In another embodiment, separate weighted outputs can be produced for different interpretive categories, such as positivity, negativity, toxicity, abusiveness, urgency, approval, or emotional tone. In another embodiment, the workflow (400) is used in a one-versus-rest manner across multiple sentiment-like categories, with each category receiving a confidence-weighted recognition scaling. These variants preserve the same structural relationship among the text input for sentiment analysis (410), the raw sentiment score (420), the classifier confidence (430), the recognition coverage weighting stage (440), the sentiment intensity computation stage (450), and the weighted sentiment output (460).

In embodiments, the weighted sentiment output (460) can also be consumed outside strictly sentiment-centric systems. For example, the weighted sentiment output (460) can be passed to a downstream ranking module, recommendation module, response-selection module, or combined scoring workflow. Where the present application's broader combined-scoring pathway is used, the weighted sentiment output (460) can function as a confidence-sensitive sentiment input to a later aggregation stage. In such embodiments, the workflow (400) contributes one bounded and interpretable signal among multiple recognition-derived signals, thereby allowing sentiment-related information to influence a final decision without overwhelming other factors such as semantic alignment, contextual coherence, or reranking quality.

The workflow (400) is also suitable for deployment as a post-processing stage that does not require retraining of the underlying classifier. In one embodiment, a baseline sentiment or moderation model produces the raw sentiment score (420) and the classifier confidence (430), and the recognition sentiment analysis workflow (400) is then applied downstream to compute the weighted sentiment output (460). This permits integration of the workflow (400) into existing moderation, analytics, review-processing, or content-analysis stacks without replacing or retraining the base model. In another embodiment, a separately fine-tuned classifier is used upstream, and the workflow (400) still operates as a distinct recognition-based post-processing stage applied to the outputs of that classifier. Thus, the disclosed architecture preserves flexibility in model choice while maintaining a clear separation between the underlying prediction engine and the recognition-based confidence-weighting logic.

In embodiments, the computational operations required by the workflow (400) are modest. Once the raw sentiment score (420) and classifier confidence (430) have been obtained, the recognition coverage weighting stage (440) evaluates the recognition coverage function using the shared constant X_opt, and the sentiment intensity computation stage (450) performs a scalar multiplication to generate the weighted sentiment output (460). Because these operations are lightweight relative to full model inference, the workflow (400) can be deployed in real-time systems, batch-analysis systems, streaming moderation environments, customer-feedback pipelines, recommendation environments, or other latency-sensitive NLP systems. In high-throughput embodiments, the workflow (400) can be applied to many text items in parallel without materially changing the architecture of the upstream classifier.

In another useful embodiment, the workflow (400) can reduce overreaction to noisy or weakly supported classifications. For example, where a classifier produces a strongly signed raw sentiment score (420) but does so with weak confidence, the recognition coverage weighting stage (440) suppresses the magnitude of the resulting weighted sentiment output (460), thereby making downstream systems less likely to act as though the underlying classification were fully reliable. Conversely, where the classifier produces both a strong raw sentiment score (420) and strong classifier confidence (430), the weighted sentiment output (460) preserves more of that intensity and can be used more aggressively in downstream ranking or moderation logic. This confidence-sensitive modulation is especially useful in noisy, ambiguous, domain-shifting, or adversarial text environments.

The workflow (400) is compatible with multiple deployment topologies. In one embodiment, the text input for sentiment analysis (410), raw sentiment score (420), classifier confidence (430), recognition coverage weighting stage (440), sentiment intensity computation stage (450), weighted sentiment output (460), and moderation or analytics decision output (470) all operate on a single device or server. In another embodiment, the raw sentiment score (420) and classifier confidence (430) are produced by a remote model service, and the recognition sentiment analysis workflow (400) is executed locally or by another downstream service. In another embodiment, the workflow (400) is embedded within a larger content pipeline that includes storage, queueing, routing, policy evaluation, or reporting infrastructure. These implementation choices do not alter the disclosed recognition-weighted sentiment mechanism.

Accordingly, FIG. 4 illustrates a recognition sentiment analysis workflow (400) in which a text input for sentiment analysis (410), a raw sentiment score (420), and a classifier confidence (430) are processed using a recognition coverage weighting stage (440) and a sentiment intensity computation stage (450) to generate a weighted sentiment output (460) and, in some embodiments, a moderation or analytics decision output (470). This workflow provides a concrete and bounded mechanism for confidence-sensitive sentiment weighting and can be used in moderation, analytics, review ranking, feedback triage, emotion-related classification, toxicity handling, or other natural language processing systems in which predictive certainty should influence the practical effect of a sentiment-related output.

Referring to FIG. 5, a recognition token reranking workflow (500) can receive a candidate token, passage, or document set (510) together with a relevance score input (520). In embodiments, the candidate token, passage, or document set (510) can include next-token candidates produced during generation, beam-search hypotheses, retrieved passages in a retrieval-augmented generation pipeline, ranked search results, candidate answers, candidate documents, candidate snippets, candidate labels, or other selectable outputs generated by an upstream natural language processing component. The relevance score input (520) can include any score, similarity value, ranking value, retrieval value, confidence-associated utility value, or other scalar quantity indicative of how well a particular candidate matches a query, prompt, context, response objective, or downstream task objective. The recognition token reranking workflow (500) is therefore configured to convert candidate-associated relevance values into recognition-based reranking weights that can be used to reorder, filter, normalize, or select among the available candidates.

In one embodiment, each candidate in the candidate token, passage, or document set (510) is associated with a relevance quantity r_k. Where that quantity is already nonnegative, it can be used directly by the workflow (500). Where the incoming quantity is not nonnegative, a nonnegative score transform (530) can convert the incoming score into a nonnegative form suitable for recognition-based weighting. A reranking weight computation stage (540) then computes a reranking weight for each candidate using the recognition coverage function. In one embodiment, the reranking weight is given by w_k=F_cov(r_k)=r_k/(r_k+X_opt). A ranked candidate list (550) can then be generated from the resulting reranking weights, and in some embodiments normalized candidate weights (560) can also be computed. A selected candidate output (570) can then be produced for downstream use by a generation model, search engine, ranking engine, response-selection system, or other NLP pipeline component.

The candidate token, passage, or document set (510) can arise in many different NLP settings. In one embodiment, the candidate token, passage, or document set (510) comprises a set of retrieved passages returned by a retriever in response to a user query. In another embodiment, the candidate token, passage, or document set (510) comprises next-token candidates or beam-search hypotheses produced during sequence generation. In another embodiment, the candidate token, passage, or document set (510) comprises answer candidates, response candidates, document search hits, semantic search results, or classification alternatives. The workflow (500) is not limited to any one candidate type and instead applies a common reranking mechanism to a broad class of NLP-generated candidate objects so long as a relevance quantity can be associated with each candidate.

The relevance score input (520) can also vary by embodiment. In one embodiment, the relevance score input (520) is a retrieval score generated by a sparse retriever, dense retriever, hybrid retriever, or search engine. In another embodiment, the relevance score input (520) is a similarity score between a query representation and a candidate representation. In another embodiment, the relevance score input (520) is a model-produced score for a next-token candidate, a beam hypothesis, or an answer candidate. In still another embodiment, the relevance score input (520) can be derived from confidence, utility, ranking priority, semantic match, or another criterion indicating candidate desirability. Thus, the workflow (500) does not depend on a specific upstream ranking source, provided that the incoming score can be interpreted or transformed into a nonnegative quantity suitable for recognition-based weighting.

The nonnegative score transform (530) is useful in embodiments where the incoming score is signed, centered around zero, or otherwise not directly compatible with the recognition coverage function. In one embodiment, the nonnegative score transform (530) applies a shift to move all candidate scores into a nonnegative range. In another embodiment, the nonnegative score transform (530) applies clipping, rectification, absolute value, normalization, or another transform that preserves useful candidate-order information while generating a nonnegative score. In another embodiment, the nonnegative score transform (530) is omitted entirely because the relevance score input (520) is already nonnegative when received. The presence of the nonnegative score transform (530) therefore provides implementation flexibility without changing the core reranking mechanism.

The reranking weight computation stage (540) computes a recognition-based weight from the relevance score input (520), or from the transformed score output of the nonnegative score transform (530), using the shared constant X_opt. In one embodiment, the resulting reranking weight is w_k=r_k/(r_k+X_opt). Because the recognition coverage function is bounded and monotone over nonnegative inputs, the reranking weight computation stage (540) produces weights that increase with candidate relevance while remaining finite and controlled. A candidate with a larger relevance quantity receives a larger reranking weight, but the weight remains bounded below one for finite nonnegative inputs. This provides a soft weighting posture in which candidate importance can vary continuously rather than being controlled solely by rigid thresholding or unbounded raw-score magnitudes.

One useful feature of the workflow (500) is that it preserves graded influence across candidates. In conventional ranking systems, candidates falling below a threshold may be discarded entirely, even if their scores are only marginally lower than those of retained candidates. By contrast, the reranking weight computation stage (540) produces a reranking weight for each candidate based on the candidate's own relevance quantity. Accordingly, multiple candidates can remain available with different recognition-based weights, and downstream systems can make use of this graded candidate structure. This is especially useful in retrieval-augmented generation, beam search, answer ranking, and other settings in which borderline candidates may still contain useful information even if they are not ultimately selected as the top result.

After reranking weights have been computed, the workflow (500) can generate the ranked candidate list (550). In one embodiment, the ranked candidate list (550) is generated by sorting candidates in descending order of reranking weight. In another embodiment, the ranked candidate list (550) preserves original candidate order for ties while reordering non-tied candidates according to their computed reranking weights. In another embodiment, the ranked candidate list (550) includes only a selected subset of the candidate token, passage, or document set (510), such as the top k candidates by reranking weight. In another embodiment, the ranked candidate list (550) can be used to allocate downstream attention, context budget, generation budget, or review priority among the candidates. Thus, the ranked candidate list (550) can serve not only as a sorted output, but also as an intermediate structure for later NLP decisions.

In some embodiments, normalized candidate weights (560) can also be computed. In one embodiment, the normalized candidate weights (560) are computed according to W_k=w_k/sum_j w_j, where the sum is taken over the retained candidate set. This produces a normalized weighting distribution over the candidate set, allowing the downstream system to interpret candidate importance proportionally rather than only ordinally. In embodiments, the normalized candidate weights (560) can be used to allocate retrieval context budget among passages, assign weighted influence to multiple hypotheses, distribute probability-like attention across candidate answers, or combine evidence from several ranked candidates rather than selecting only one. The normalized candidate weights (560) therefore provide a useful extension of the reranking mechanism in embodiments that benefit from multi-candidate weighting rather than single-candidate selection alone.

The selected candidate output (570) can be generated in various ways. In one embodiment, the selected candidate output (570) is the single candidate associated with the highest reranking weight. In another embodiment, the selected candidate output (570) comprises a reduced candidate subset, such as the top-ranked passages to be fed into a generative model or the top-ranked beam hypotheses to be retained during decoding. In another embodiment, the selected candidate output (570) includes a set of candidates together with their normalized candidate weights (560), thereby allowing a downstream system to consume both identity and relative importance information. In another embodiment, the selected candidate output (570) can be a routing signal, display order, recommendation order, or another operational output derived from the reranking results.

One important use case for the workflow (500) is retrieval-augmented generation. In such an embodiment, the candidate token, passage, or document set (510) comprises a set of retrieved passages returned for a query or prompt, and the relevance score input (520) comprises retrieval scores associated with those passages. The reranking weight computation stage (540) computes recognition-based passage weights, and the ranked candidate list (550) orders the passages accordingly. The selected candidate output (570) can then comprise one or more top-ranked passages, or a weighted subset of passages, to be provided to a downstream generative model as contextual support. In such systems, the workflow (500) can improve the handling of near-boundary retrieval candidates by preserving graded relevance information rather than relying solely on unmodified raw retrieval order.

Another useful application is beam-search reranking during sequence generation. In such an embodiment, the candidate token, passage, or document set (510) comprises next-token candidates or beam-search hypotheses, and the relevance score input (520) comprises beam scores, transformed beam scores, or another hypothesis-utility measure. The reranking weight computation stage (540) computes recognition-based weights for the competing hypotheses, and the ranked candidate list (550) can then be used to retain the most promising hypotheses or to reweight their downstream influence. In embodiments, this can provide a bounded and interpretable reranking layer for generation systems, particularly where raw generation scores are not directly suitable for downstream comparison or where preservation of graded candidate influence is desirable.

The workflow (500) can also be used in document ranking and answer selection systems. In one embodiment, the candidate token, passage, or document set (510) comprises search-result documents, and the selected candidate output (570) is a reranked search-results list. In another embodiment, the candidate token, passage, or document set (510) comprises answer candidates for a question-answering system, and the reranking weights are used to identify the most relevant answer or the most useful subset of answers. In another embodiment, the workflow (500) is used in summarization or content-selection pipelines, where candidate sentences or passages are reranked before inclusion in a generated summary or report. These embodiments demonstrate that the recognition token reranking workflow (500) is broadly applicable to ranking-intensive NLP scenarios.

In embodiments, the workflow (500) can operate alone or in combination with other recognition-based workflows. In one embodiment, the reranking weight produced by the reranking weight computation stage (540) is used independently to select or prioritize candidates. In another embodiment, the reranking weight serves as one input to a combined scoring pipeline together with alignment, coherence, or confidence-weighted sentiment information. In another embodiment, the workflow (500) follows upstream recognition semantic embedding or recognition contextual coherence processing, such that the candidate-associated relevance values have already been influenced by other recognition-based operations. This modular compatibility allows the workflow (500) to act as a standalone reranking mechanism or as one component within a broader recognition-based NLP architecture.

The workflow (500) is particularly well suited to post-processing deployment. In one embodiment, an upstream retriever, generator, or search engine produces the candidate token, passage, or document set (510) and the associated relevance score input (520), and the recognition token reranking workflow (500) is applied downstream without modifying the upstream model parameters. This allows the workflow (500) to be added to existing search stacks, retrieval systems, generation systems, recommendation pipelines, or answer-ranking systems with limited architectural disruption. In another embodiment, the upstream model may be separately fine-tuned or otherwise adapted, while the reranking workflow (500) still operates as a distinct recognition-based stage. Thus, the disclosed reranking mechanism remains compatible with both frozen-model and adapted-model deployments.

In embodiments, the computational requirements of the workflow (500) are modest relative to full retrieval or model inference. Once the candidate token, passage, or document set (510) and the relevance score input (520) have been obtained, the workflow principally performs optional score transformation, recognition-function evaluation, sorting, optional normalization, and candidate selection. These operations are well suited to real-time systems, batch processing systems, retrieval systems, and high-throughput generation environments. Where candidate-set size is large, the workflow (500) can be applied to a truncated candidate pool, a staged candidate pool, or a dynamically selected subset without departing from the disclosed recognition-based reranking principle.

The workflow (500) also supports multiple deployment topologies. In one embodiment, the candidate token, passage, or document set (510), relevance score input (520), nonnegative score transform (530), reranking weight computation stage (540), ranked candidate list (550), normalized candidate weights (560), and selected candidate output (570) all operate on a single processor or within a single service. In another embodiment, candidate generation occurs remotely and the reranking workflow (500) is executed by a downstream service. In another embodiment, portions of the workflow are distributed across a retrieval tier, a ranking tier, and a generation tier. These implementation choices do not alter the underlying mechanism by which recognition-based weights are derived from candidate-associated relevance quantities.

Accordingly, FIG. 5 illustrates a recognition token reranking workflow (500) in which a candidate token, passage, or document set (510) and a relevance score input (520) are processed, optionally through a nonnegative score transform (530), by a reranking weight computation stage (540) to generate a ranked candidate list (550), optionally normalized candidate weights (560), and a selected candidate output (570). This workflow provides a concrete and bounded reranking mechanism for retrieval-augmented generation, beam-search reranking, document ranking, answer selection, summarization support, semantic search, and other natural language processing applications in which candidate desirability should be represented through continuous recognition-based weighting rather than solely by hard thresholding or unbounded raw scores. Referring again to FIG. 6, a combined semantic prediction workflow (600) can integrate one or more outputs generated by the previously described recognition-based workflows and can convert those outputs into a unified decision-oriented quantity for downstream use. In the illustrated arrangement, the combined semantic prediction workflow (600) receives an alignment score input (610), a coherence score input (620), a confidence-weighted sentiment input (630), and a reranking weight input (640). These inputs can be derived, respectively, from the recognition semantic embedding workflow, the recognition contextual coherence workflow, the recognition sentiment analysis workflow, and the recognition token reranking workflow. A mixture weight generator (650) computes mixture weights from the shared recognition-scale constant X_opt, and a combined score computation stage (660) uses those mixture weights to compute a bounded combined score for one or more candidates. A candidate comparison or selection stage (670) then compares candidates according to the combined score, and a final semantic prediction output (680) can be delivered to the downstream task module for classification, generation, retrieval, ranking, filtering, routing, or another natural language processing task.

The combined semantic prediction workflow (600) is useful because it provides a system-level mechanism for integrating multiple recognition-derived signals without requiring the recognition mappings themselves to be fitted using additional empirical coefficients. In embodiments, the workflow (600) combines signals that are individually bounded or controllably scaled and therefore can be aggregated into a common decision quantity even where the upstream model outputs originated on different native scales. This is particularly useful in natural language processing pipelines in which semantic fit, discourse-level coherence, confidence-sensitive interpretive output, and candidate relevance each contribute meaningful but distinct information to a downstream decision. Rather than relying on a single type of model output, the workflow (600) permits the system to take into account multiple aspects of candidate quality within one combined score.

In one embodiment, the alignment score input (610) is derived from the recognition semantic embedding workflow and reflects how naturally a candidate token or other candidate language unit fits its context after recognition-based contextual comparison. One suitable definition is A(token,C)=1−scale(token,C), where scale(token,C) corresponds to the recognition scale factor computed for the candidate token relative to a relevant context C. Under this definition, a candidate that requires less recognition-based correction can receive a higher alignment score, while a candidate requiring greater correction can receive a lower alignment score. In embodiments, this makes the alignment score input (610) a useful measure of native contextual fit. In ambiguity-sensitive applications, such as word-sense disambiguation or answer selection, the alignment score input (610) can therefore represent whether a candidate already aligns well with the contextual environment in which it appears.

The coherence score input (620) can be derived from the recognition contextual coherence workflow and can represent the semantic and positional coherence of a sentence, passage, response, or other text unit associated with a candidate. In one embodiment, the coherence score input (620) is given by a sentence-level or passage-level coherence quantity such as C_sem(S), computed by aggregating recognition-weighted pairwise semantic contributions. In embodiments, the coherence score input (620) functions as a structural quality measure that indicates how well the candidate's surrounding text holds together as a semantically continuous unit. A candidate whose associated response, passage, or output exhibits greater discourse continuity can therefore receive a higher coherence score input (620) than a candidate whose associated text is fragmented, topically inconsistent, or semantically weak. This allows the workflow (600) to account for not only token-level or retrieval-level desirability, but also the global or local coherence of the content associated with the candidate.

The confidence-weighted sentiment input (630) can be derived from the recognition sentiment analysis workflow and can represent a confidence-sensitive interpretive quantity associated with the candidate or with text associated with the candidate. In one embodiment, the confidence-weighted sentiment input (630) is given by S_intensity(T)=S_raw(T)*F_cov(Conf_sent(T)), or by the corresponding confidence-derived weighting term used therein. In some embodiments, the combined score computation stage (660) uses the full weighted sentiment quantity. In other embodiments, the combined score computation stage (660) uses the recognition-weighted confidence factor itself, such as F_cov(Conf_sent(T)), where the workflow is concerned more directly with confidence-weighted support than with sentiment sign. The confidence-weighted sentiment input (630) is therefore flexible in implementation while still remaining tied to the disclosed recognition-based confidence-weighting mechanism.

The reranking weight input (640) can be derived from the recognition token reranking workflow and can correspond to a candidate-specific recognition-based reranking weight. In one embodiment, the reranking weight input (640) is given by w_token=F_cov(r) or, more generally, by a candidate-specific weight w_k=F_cov(r_k), where r_k is a nonnegative relevance quantity for the corresponding candidate. Because this reranking weight is bounded and monotone in relevance, it provides the workflow (600) with a soft measure of candidate desirability that is already normalized into a recognition-compatible form. In embodiments, the reranking weight input (640) is particularly useful in retrieval-augmented generation, beam-search evaluation, answer selection, passage ranking, or document ranking, where the relative strength of candidates should influence the final decision without requiring that all but one candidate be discarded prematurely.

The mixture weight generator (650) computes mixture weights derived only from X_opt. In one embodiment, the mixture weight generator (650) computes Z_mix=1+X_opt+X_opt\hat{ }2+X_opt\hat{ }3, alpha=1/Z_mix, beta=X_opt/Z_mix, gamma=X_opt\hat{ }2/Z_mix, and delta=X_opt′/Z_mix. These coefficients are then supplied to the combined score computation stage (660). Because the coefficients are derived from X_opt, the recognition mappings remain parameter-free in the sense that no additional empirical tuning coefficients are introduced within the recognition-based combination itself. Conventional model-development and deployment choices, such as model selection, tokenizer selection, context-window size, retrieval depth, batching strategy, candidate-set size, latency constraints, and hardware configuration, can still vary by embodiment, but the mixture generation used within the recognition-based combined score can remain grounded solely in the shared recognition-scale constant.

The combined score computation stage (660) computes a combined score for each candidate using the mixture weights from the mixture weight generator (650) and the supplied inputs. In one embodiment, the combined score is given by Score(token)=alpha*A(token,C)+beta*C_sem(S)+gamma*F_cov(Conf_sent(T))+delta*w_token. In another embodiment, the same structure can be written in candidate-indexed form using w_k or another candidate-specific score variable. Because each component term is bounded and because the coefficients are selected such that their sum is normalized through Z_mix, the resulting combined score is bounded regardless of the native scale of the raw model outputs from which the component inputs were originally derived. This boundedness is useful because it makes the combined score more stable and comparable across different candidates, tasks, or embodiments.

In embodiments, the combined score computation stage (660) provides a unified decision quantity that reflects multiple distinct aspects of candidate quality. The alignment term contributes information about contextual fit at the representation level. The coherence term contributes information about sentence-level or passage-level semantic continuity. The confidence-related term contributes information about the reliability or support associated with interpretive output. The reranking term contributes information about retrieval or candidate relevance. By aggregating these terms, the workflow (600) can evaluate a candidate using a broader evidentiary basis than a single model output alone. This can be especially useful where the strongest candidate is not simply the candidate with the highest raw relevance or the highest local alignment, but rather the candidate that best balances multiple recognition-derived considerations.

The candidate comparison or selection stage (670) compares candidates according to the combined score produced by the combined score computation stage (660). In one embodiment, the candidate comparison or selection stage (670) selects the candidate associated with the highest combined score. In another embodiment, the candidate comparison or selection stage (670) generates a ranked list of candidates ordered by combined score. In another embodiment, the candidate comparison or selection stage (670) retains a subset of top-scoring candidates for downstream processing, such as passage packaging for generation, hypothesis continuation during decoding, or answer shortlist generation in question answering. In another embodiment, the candidate comparison or selection stage (670) can use the combined score to generate a routing or control decision rather than directly selecting content for display. Thus, the workflow (600) supports both direct selection and broader score-driven downstream control.

The final semantic prediction output (680) can take different forms depending on the application. In one embodiment, the final semantic prediction output (680) is a selected token or next-token candidate in a generation setting. In another embodiment, the final semantic prediction output (680) is a selected word sense or semantic label in an ambiguity-resolution setting. In another embodiment, the final semantic prediction output (680) is a selected answer, selected passage, selected document, selected moderation action, selected ranking order, or another operationally meaningful NLP output. In some embodiments, the final semantic prediction output (680) can include both candidate identity and one or more associated score values. In other embodiments, the final semantic prediction output (680) can be a control signal indicating that a downstream system should accept, reject, escalate, re-rank, or further process a candidate or group of candidates.

In one embodiment, the final semantic prediction output (680) is used as a gating signal for downstream tasks. For example, the downstream task module can accept a candidate for presentation or execution if the combined score exceeds a threshold, can defer the candidate for fallback handling if the combined score falls below a threshold, or can escalate the candidate for additional review if two or more candidates remain within a selected score margin. In another embodiment, the final semantic prediction output (680) is used to determine whether a generated response is sufficiently coherent and contextually aligned to be shown to a user. In another embodiment, the final semantic prediction output (680) is used to decide which retrieval candidates should be included in a context package for a generative model. In another embodiment, the final semantic prediction output (680) is used to gate a moderation action, a routing action, or a segmentation action. These gating embodiments show that the workflow (600) is not limited to producing a ranked score, but can also drive concrete downstream operational decisions.

In some embodiments, the workflow (600) can be used with all four illustrated inputs, while in other embodiments fewer than all four inputs are used. For example, the combined score computation stage (660) can operate using only an alignment score input (610) and a reranking weight input (640), or using only a coherence score input (620) and a reranking weight input (640), or using any other subset of the disclosed inputs depending on which upstream workflows are active in a given deployment. In one embodiment, the recognition-based natural language processing system uses only one recognition-based subsystem and omits the combined score entirely. In another embodiment, the system uses two or more subsystems together but does not require all four. In another embodiment, the workflow (600) is present as an optional integration layer that can be bypassed when a downstream task is better served by directly consuming outputs from one or more upstream modules. These variations preserve the disclosed modular architecture while making clear that the combined score is optional rather than mandatory. The optional nature of the workflow (600) is important for maintaining architectural flexibility. In some deployments, a system may rely primarily on the recognition token reranking workflow to improve retrieval ordering and may not need to combine coherence or sentiment information. In other deployments, a system may use recognition semantic embedding and recognition contextual coherence together to improve generation quality without using the sentiment pathway. In still other deployments, all four recognition-based inputs can be computed and passed through the workflow (600) for a fully integrated score. By describing the combined score as optional and subset-compatible, the present disclosure supports both narrower and broader embodiments while remaining aligned with the disclosed invention.

In embodiments, the combined score computation stage (660) can also facilitate cross-scale comparison because the component terms are recognition-weighted and therefore bounded. Conventional NLP systems often generate raw outputs whose scales differ substantially across tasks or models, which can make multi-signal comparison difficult without ad hoc calibration. By contrast, the workflow (600) uses recognition-derived weighting to place diverse quantities into a more uniform bounded form before or during aggregation. This can simplify downstream comparison logic and can reduce sensitivity to arbitrary raw-score magnitude differences. The resulting combined score can therefore serve as a practical common currency for candidate evaluation within a larger NLP pipeline.

The workflow (600) is compatible with both standalone and integrated use. In one embodiment, the workflow (600) is used as the principal decision engine for selecting among competing candidates. In another embodiment, the workflow (600) is used as an intermediate scoring layer whose output is supplied to a separate policy engine, ranking engine, moderation engine, or application-specific control system. In another embodiment, the final semantic prediction output (680) can be logged, audited, compared against baseline scores, or used in deployment tuning and evaluation, even where the ultimate externally visible decision is made by another system. This flexibility allows the workflow (600) to serve as a selectable decision layer, a scoring utility, or a support layer within larger NLP architectures.

In embodiments, the computational requirements of the workflow (600) remain practical because the component inputs are already produced by upstream workflows and the main additional operations are mixture-weight computation, score aggregation, candidate comparison, and optional threshold or margin logic. These operations are relatively lightweight compared with full model inference and can be executed in real time, in batch mode, or in hybrid streaming systems. The workflow (600) can therefore be deployed in latency-sensitive interactive systems as well as in offline analytics, retrieval, or content-processing systems.

Accordingly, FIG. 6 illustrates a combined semantic prediction workflow (600) in which an alignment score input (610), a coherence score input (620), a confidence-weighted sentiment input (630), and a reranking weight input (640) are supplied to a mixture weight generator (650) and a combined score computation stage (660), after which a candidate comparison or selection stage (670) produces a final semantic prediction output (680). This workflow provides a concrete and bounded mechanism for integrating multiple recognition-derived signals into a unified downstream decision quantity, while making clear that the combined score is optional, that any one disclosed subsystem or any subset of the disclosed subsystems can be used alone or together, and that the recognition mappings themselves do not require additional empirical tuning coefficients beyond the shared use of X_opt, even though ordinary model-training and deployment choices can still vary by embodiment.

Referring to FIG. 8, an ambiguity-resolution workflow (800) can illustrate a word-sense-disambiguation embodiment in which an ambiguous token (810) is interpreted using a conversation-history context (820) and a candidate sense set (830). In one example, the input sentence is “She walked to the river bank to fish,” and the ambiguous token (810) is the word “bank.” In this example, the candidate sense set (830) includes at least a financial-institution sense and a geographic-river-edge sense. A context embedding for ambiguity resolution (840) is generated from the conversation-history context (820) or the local sentence context, such as the terms “river,” “walked,” and “fish.” A distance comparison stage (850) compares the candidate senses against the context embedding for ambiguity resolution (840), and a recognition correction magnitude stage (860) evaluates recognition correction values or correction proxies for the candidate senses. In one illustrative implementation, the original embedding for “bank” is treated as a mixed or averaged representation across competing senses, the context-derived embedding is pulled strongly toward the geographic sense, the semantic distance is taken as d=1.35, and the recognition scale is scale=F_cov(1.35)=1.35/(1.35+0.515)=0.724. A recognition-enhanced embedding is then produced according to E_rec(“bank”)=E_orig(“bank”)+0.724*(E_context−E_orig(“bank”)). A preferred sense selection stage (870) can then select the geographic sense because it is more compatible with the context and, in embodiments, requires the smaller recognition correction or smaller correction-magnitude proxy. The resulting disambiguated output (880) therefore resolves “bank” as a river edge rather than as a financial institution.

This “bank” example is useful because it shows how the disclosed recognition semantic embedding logic can be used in a concrete lexical ambiguity setting without modifying the underlying model weights. The inputs are expressly identifiable: the ambiguous token (810), the surrounding context, and the candidate sense set (830). The intermediate values are likewise identifiable: the context embedding for ambiguity resolution (840), the semantic distance, and the recognition scale value. The module output is the context-shifted recognition-enhanced embedding and the sense preference generated at the preferred sense selection stage (870). The comparative result is that the geographic interpretation is preferred over the financial interpretation because the surrounding language strongly supports the geographic reading. This example therefore supplies practical support for using the disclosed workflow in word-sense disambiguation, semantic search disambiguation, answer selection, and other context-sensitive semantic interpretation tasks.

Referring again to FIG. 3, a recognition contextual coherence workflow (300) can illustrate a high-coherence-versus-low-coherence comparison. In one example, the sentence or text segment (310) is “The doctor examined the patient carefully before prescribing,” and the enhanced embedding input set (320) includes recognition-enhanced embeddings corresponding to the tokens of that sentence. The token-pair generator (330) generates token pairs from the sentence, the cosine similarity computation stage (340) computes similarity values for those pairs, the positional distance computation stage (350) computes token separations, and the weighted coherence term computation stage (360) generates weighted pairwise contributions. In this example, the token embeddings are semantically related within a medical context, the pairwise cosine similarities are approximately 0.85, the positional distances span a range such as 1 through 6, and the corresponding recognition positional weights fall in a range such as approximately 0.66 to 0.92. Using an average effective coverage factor of approximately 0.78, the coherence score output (370) can be estimated as C_sem(A)≈0.85*0.78=0.663. The resulting coherence-based decision output (380) can indicate that the sentence is highly coherent, semantically unified, and suitable for acceptance or for ranking above less coherent candidates. By contrast, in a comparative low-coherence example, the sentence or text segment (310) is “The sky runs Tuesday quietly purple elephant.” In this second example, the same workflow (300) is applied, but the embeddings of the token sequence are largely semantically unrelated. The cosine similarity computation stage (340) therefore produces much smaller values, for example approximately 0.05 to 0.15, while the positional distance computation stage (350) can still produce a similar pattern of positional separations as in the high-coherence example. With the same average coverage factor of approximately 0.78, the coherence score output (370) can be estimated as C_sem(B)≈0.10*0.78=0.078. The comparative result is that the high-coherence sentence yields a coherence score roughly 8.5 times greater than the low-coherence sentence. This example is useful because it demonstrates that the recognition contextual coherence workflow (300) can cleanly separate semantically coherent text from incoherent or randomly assembled text. The module output is the scalar coherence score output (370), and the comparative result supports use of the workflow (300) in output-quality scoring, document segmentation, readability analysis, discourse analysis, or ranking of generated text.

Referring to FIG. 4, a recognition sentiment analysis workflow (400) can illustrate a confidence-weighted sentiment comparison. In one example, the text input for sentiment analysis (410) is the review “This product is pretty good, I suppose.” A baseline classifier produces a raw sentiment score (420) of S_raw=+0.65, indicating mildly positive sentiment, together with a classifier confidence (430) of Conf=0.52, indicating uncertainty or only moderate confidence in that assessment. The recognition coverage weighting stage (440) computes F_cov(0.52)=0.52/(0.52+0.515)=0.52/1.035=0.502, and the sentiment intensity computation stage (450) computes S_intensity=0.65*0.502=0.326. The weighted sentiment output (460) therefore reflects a confidence-sensitive reduction in the effective magnitude of the underlying sentiment signal. In this example, the moderation or analytics decision output (470) can indicate that the review is positive but only moderately supported and therefore may be treated with less downstream force than a more confident positive review.

A comparative example uses the review “This product is absolutely excellent!” In that case, the raw sentiment score (420) is S_raw=+0.95 and the classifier confidence (430) is Conf=0.97. The recognition coverage weighting stage (440) computes F_cov(0.97)=0.97/(0.97+0.515)=0.97/1.485=0.653, and the sentiment intensity computation stage (450) computes S_intensity=0.95*0.653=0.620. The weighted sentiment output (460) is therefore substantially larger than in the prior example, reflecting both stronger raw positivity and stronger predictive confidence. In another comparative illustration, two reviews can have the same raw sentiment score but different confidence values. For example, where S_raw=0.80 and Conf=0.60, the resulting recognition-weighted value is approximately 0.80*0.538=0.430, whereas where S_raw=0.80 and Conf=0.95, the resulting value is approximately 0.80*0.649=0.519. The comparative result is that the workflow (400) correctly ranks the high-confidence review above the lower-confidence review even when the raw sentiment magnitudes are identical. This example therefore illustrates that the weighted sentiment output (460) and moderation or analytics decision output (470) can be made more confidence-sensitive than in conventional systems that merely consume the raw sentiment label or raw sentiment score.

Referring to FIG. 9, a retrieval and reranking workflow (900) can illustrate a retrieval-augmented-generation example. In one embodiment, the search query (910) is “What are the symptoms of Type 2 diabetes?” and the retrieved passage set (920) includes multiple retrieved passages, each with an associated passage relevance score (930). In one illustrative example, Passage A has r=3.5 and directly addresses diabetes symptoms, Passage B has r=1.8 and provides general diabetes overview information, Passage C has r=0.4 and addresses general endocrinology, and Passage D has r=0.08 and concerns an unrelated metabolic disorder. A recognition reranking stage (940) computes recognition-based passage weights according to the disclosed reranking logic. In this example, the resulting weights are w_A=F_cov(3.5)=3.5/4.015=0.872, w_B=F_cov(1.8)=1.8/2.315=0.778, w_C=F_cov(0.4)=0.4/0.915=0.437, and w_D=F_cov(0.08)=0.08/0.595=0.134.

In some embodiments, normalized passage weights (950) are then computed. Using the illustrative values above, the normalized passage weights (950) can be approximately A=0.444, B=0.396, C=0.222, and D=0.068. A context package for a generative model (960) can then be formed by emphasizing the highly relevant passages while still preserving a small amount of graded influence for lower-ranked candidates. The reranked output set (970) can therefore provide a better balanced and less noisy set of contextual passages for generation, and the generated response or retrieval output (980) can be formed using that reranked evidence package. The comparative result is that the unrelated passage contributes less than approximately seven percent of the effective context weight, thereby reducing irrelevant dilution, but is not discarded by a rigid hard threshold. This example is useful because it demonstrates the practical effect of the recognition token reranking logic in a concrete RAG setting and shows how the workflow can preserve graded relevance information while still strongly preferring more relevant passages. Referring again to FIG. 8, another ambiguity-resolution example can be framed as a conversational AI query involving the ambiguous token (810) “Apple.” In one embodiment, a user asks, “What about the Apple announcement?” and the conversation-history context (820) contains prior discussion about technology earnings, devices, product launches, or corporate news. In this example, the candidate sense set (830) includes at least a company-related sense and a fruit-related sense. A context embedding for ambiguity resolution (840) is generated from the conversation-history context (820), and a distance comparison stage (850) compares the candidate senses against that context embedding. Because the prior messages are strongly technology-oriented, the context embedding for ambiguity resolution (840) lies much closer to the company-related candidate sense than to the fruit-related candidate sense. The recognition correction magnitude stage (860) therefore yields a smaller correction value or smaller correction proxy for the company-related interpretation. The preferred sense selection stage (870) accordingly selects the company-related sense, and the disambiguated output (880) can then be used by a downstream task module to interpret the user's query in a manner consistent with the conversation history.

This “Apple” example is useful because it demonstrates that the disclosed recognition-semantic logic can operate not only on sentence-local context but also on a broader conversational context. The inputs are the ambiguous token (810), the prior-message history that defines the conversation-history context (820), and the candidate sense set (830). The intermediate values are the context embedding for ambiguity resolution (840), the semantic-distance comparisons at the distance comparison stage (850), and the recognition correction analysis at the recognition correction magnitude stage (860). The module output is the preferred sense selected at the preferred sense selection stage (870), which is then provided as the disambiguated output (880). The comparative result is that a company-related interpretation is selected over a fruit-related interpretation because the broader conversation context strongly favors the technology reading. This example therefore supports embodiments in which the disclosed workflows are applied to dialogue systems, conversational assistants, interactive search, customer-service systems, or multi-turn question-answering systems.

Referring to FIG. 1, a benchmark-performance embodiment can be described at the system level using the recognition-based natural language processing system (100), the recognition semantic embedding module (140), the recognition contextual coherence module (150), the recognition sentiment analysis module (160), the recognition token reranking module (170), the combined scoring module (180), and the downstream task module (190). In this embodiment, one or more natural language processing tasks are performed with and without one or more recognition-based modules activated, and the resulting outputs are compared using one or more verification metrics. In one embodiment, semantic accuracy improvement is evaluated using Delta_A=(A_rec−A_baseline)/A_baseline*100%, where A_rec is a task-performance measure obtained using recognition-based processing and A_baseline is the corresponding measure obtained without that processing. In another embodiment, inference latency overhead is measured by comparing end-to-end processing time with and without the recognition-based modules. In another embodiment, coherence separation is evaluated by comparing high-coherence outputs against low-coherence outputs using the coherence score output (370). In another embodiment, retrieval improvement is evaluated by comparing the relative reranking order of candidates before and after the reranking workflow has been applied.

In one benchmark-oriented comparison, the pre-trained language model or base language model (120) can be run in a baseline mode that produces only base embeddings and raw prediction outputs (130). The same system can then be run in a recognition-augmented mode in which the recognition semantic embedding module (140), recognition contextual coherence module (150), recognition sentiment analysis module (160), and recognition token reranking module (170) are used either independently or in combination, and, in some embodiments, their outputs are further integrated by the combined scoring module (180). The downstream task module (190) can then compare results across the two modes. The comparative result in such embodiments is not limited to a single type of gain. Depending on the task, the recognition-augmented mode can yield improved ambiguity resolution, stronger discrimination between coherent and incoherent text, more confidence-sensitive sentiment handling, better retrieval ranking, or improved downstream candidate selection. This benchmark-performance embodiment is useful because it ties the worked examples back to a system-level validation posture and supplies concrete support for using the disclosed workflows in comparative deployment or evaluation settings.

Taken together, these worked examples show how the disclosed invention operates across multiple task classes while remaining grounded in the same recognition-based mathematical framework. The “bank” and “Apple” examples illustrate ambiguity resolution using context-sensitive embedding refinement and sense selection. The high-coherence and low-coherence examples illustrate scalar coherence discrimination for quality evaluation and segmentation. The sentiment examples illustrate confidence-sensitive weighting of raw interpretive outputs. The RAG example illustrates soft reranking of retrieved passages without hard cutoff behavior. The benchmark-performance embodiment illustrates how these modules can be evaluated individually or jointly within the recognition-based natural language processing system (100). Accordingly, the worked examples provide concrete support for enablement, fallback claiming, and prosecution flexibility by showing not merely abstract equations, but identifiable inputs, intermediate values, module outputs, and comparative results across the principal disclosed workflows.

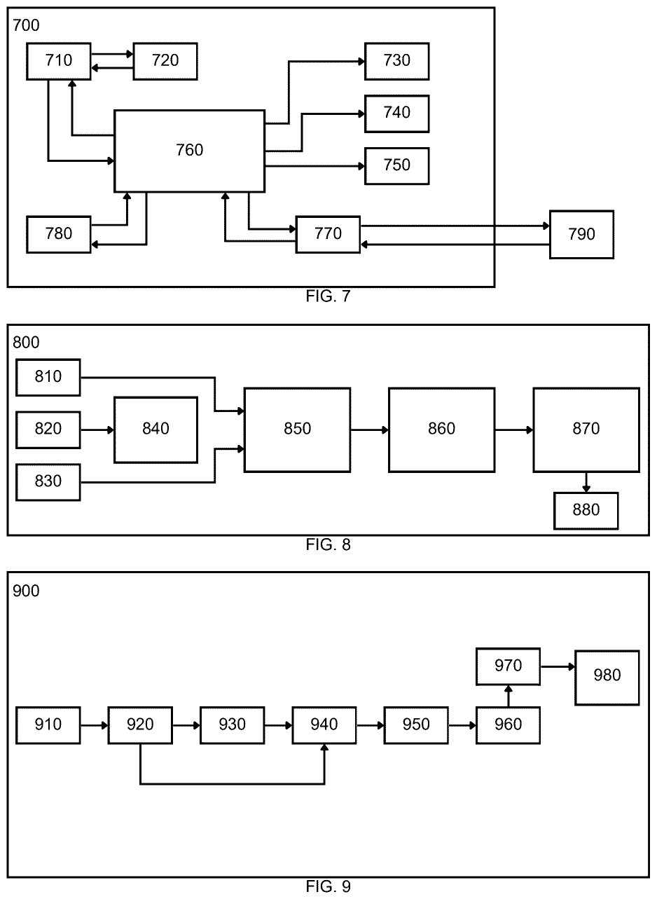

Referring to FIG. 7, a computing environment (700) can implement one or more portions of the recognition-based natural language processing system described herein. In the illustrated embodiment, the computing environment (700) includes one or more processors (710), memory (720), model storage (730), an embedding store (740), a candidate store or queue (750), an inference engine (760), a network interface (770), and an accelerator (780). The computing environment (700) can communicate with a client device or external system (790). In embodiments, the processor (710) executes instructions stored in the memory (720) to receive natural language inputs, invoke one or more baseline model operations, perform one or more recognition-based post-processing operations, and provide one or more resulting outputs to a downstream task, external service, user-facing application, storage layer, or control process. The processor (710) can include one or more general-purpose central processing units, graphics-capable processing units, tensor-oriented processing devices, vector-processing units, application-specific processors, microprocessors, or other computational devices capable of executing machine-readable instructions. In some embodiments, multiple processors (710) cooperate to perform the disclosed operations in parallel, such as where a first processor handles baseline model inference and a second processor handles one or more recognition-based post-processing workflows. In other embodiments, the processor (710) may comprise a distributed set of execution resources spanning multiple machines, containers, services, or virtualized compute instances. The present disclosure is therefore not limited to a single-chip or single-node execution environment.

The memory (720) can include volatile memory, nonvolatile memory, cache memory, working memory, persistent memory, or another machine-readable storage medium suitable for storing executable instructions and runtime data. In embodiments, the memory (720) stores instructions that cause the processor (710) to carry out operations associated with the recognition semantic embedding workflow, the recognition contextual coherence workflow, the recognition sentiment analysis workflow, the recognition token reranking workflow, and the optional combined semantic prediction workflow. The memory (720) can further store token sequences, context-window definitions, intermediate distance values, recognition scale factors, coherence terms, weighted sentiment values, reranking weights, combined scores, threshold values, routing rules, and other data structures used during operation of the disclosed system.

The model storage (730) can store one or more baseline model artifacts used by the computing environment (700). In embodiments, the model storage (730) stores model weights, tokenization assets, vocabulary files, configuration files, prompt templates, calibration data, fine-tuned checkpoints, retrieval-model parameters, classification-model parameters, or other machine-learning artifacts used upstream of or together with the recognition-based workflows. In some embodiments, the model storage (730) contains one or more transformer-based language models or embedding models. In other embodiments, the model storage (730) contains references to remotely hosted models whose outputs are consumed by the disclosed recognition-based post-processing system. The model storage (730) can therefore support fully local, hybrid, or remote model-deployment strategies.

The embedding store (740) can store embeddings used by the system before, during, or after recognition-based processing. In one embodiment, the embedding store (740) stores the base embedding set produced by a pre-trained language model or base language model. In another embodiment, the embedding store (740) stores recognition-enhanced embeddings produced by the recognition semantic embedding workflow. In another embodiment, the embedding store (740) stores context embeddings, pooled embeddings, sentence embeddings, passage embeddings, candidate-sense embeddings, or other vector representations used in downstream comparison, retrieval, ranking, or scoring. The embedding store (740) can therefore function as a persistent or transient vector repository that supports both upstream inference and downstream recognition-based computation.

The candidate store or queue (750) can store and manage candidate items subjected to recognition-based reranking, selection, filtering, or downstream decision logic. In embodiments, the candidate store or queue (750) stores candidate tokens, beam-search hypotheses, retrieved passages, documents, answer candidates, label candidates, candidate senses, or other selectable outputs produced by an upstream NLP component. Associated metadata can also be stored, including relevance values, transformed scores, confidence values, timestamps, candidate identifiers, source identifiers, ranking positions, and policy flags. In some embodiments, the candidate store or queue (750) provides a buffering function that permits candidate sets to be accumulated, updated, reordered, truncated, or normalized before a final selection or output operation is performed. This structure supports both synchronous and asynchronous candidate-handling workflows within the computing environment (700).

The inference engine (760) can execute or coordinate execution of the baseline model and the disclosed recognition-based computations. In one embodiment, the inference engine (760) invokes a baseline language model to generate base embeddings and raw prediction outputs, then applies one or more recognition-based workflows to those outputs. In another embodiment, the inference engine (760) receives outputs from a remote or previously executed baseline model and performs only the recognition-based post-processing stages. In another embodiment, the inference engine (760) orchestrates a multi-stage pipeline in which a first stage produces embeddings, a second stage computes context-sensitive recognition enhancements, a third stage computes coherence or confidence-sensitive outputs, a fourth stage performs candidate reranking, and a fifth stage computes an optional combined score for candidate selection. Thus, the inference engine (760) can act as a control layer for staged execution of the disclosed system. In embodiments, the inference engine (760) can implement the recognition semantic embedding workflow by receiving a token sequence and associated base embeddings from the embedding store (740), defining one or more context windows, computing context embeddings, computing semantic distances, computing recognition scale factors, and generating recognition-enhanced embeddings. Those recognition-enhanced embeddings can then be written back to the embedding store (740) for later use. In embodiments, the inference engine (760) can also implement the recognition contextual coherence workflow by generating token pairs, computing pairwise similarities, computing positional distances, computing weighted coherence terms, and aggregating those terms into a coherence score. In embodiments, the same inference engine (760) can compute confidence-weighted sentiment outputs and candidate reranking weights, thereby supporting a modular but unified runtime environment within the computing environment (700).

The network interface (770) can provide communication between the computing environment (700) and one or more external systems, including the client device or external system (790). In embodiments, the network interface (770) receives input text, queries, prompts, candidate sets, model outputs, retrieval results, or external control signals from another system. In embodiments, the network interface (770) transmits generated responses, reranked candidates, weighted sentiment outputs, coherence scores, selected passages, selected answers, selected tokens, or other downstream outputs to another system. The network interface (770) can support local-area communication, wide-area communication, cloud-service communication, application programming interfaces, remote procedure calls, streaming protocols, queue-backed transport, or other communication mechanisms suitable for interoperating with external NLP services, databases, user interfaces, or policy engines.

The accelerator (780) can comprise a graphics processing unit, tensor processing unit, field-programmable gate array, neural-network accelerator, vector accelerator, or another specialized computational resource that can improve execution speed for one or more of the disclosed operations. In embodiments, the accelerator (780) can be used to speed up embedding generation, vector similarity computation, batched distance computation, candidate reranking, or other matrix- or tensor-oriented operations associated with the disclosed workflows. In some embodiments, the accelerator (780) is used only for baseline model inference, while the recognition-based post-processing logic is executed on the processor (710). In other embodiments, both the baseline model and the recognition-based workflows are executed at least in part on the accelerator (780). The computing environment (700) is therefore compatible with both general-purpose and accelerated execution profiles.

The client device or external system (790) can be any system that provides inputs to, receives outputs from, or otherwise interacts with the computing environment (700). In embodiments, the client device or external system (790) can be a user workstation, mobile device, browser-based interface, chat system, enterprise workflow system, retrieval system, search platform, moderation platform, analytics dashboard, external database, application server, or another computational system. In some embodiments, the client device or external system (790) submits a natural language query and receives a selected answer, reranked passage set, or generated response. In other embodiments, the client device or external system (790) receives weighted sentiment values, coherence scores, segmentation markers, or ranking signals for use in another application. Accordingly, the computing environment (700) can be deployed as a backend service, an embedded module, a software library, a cloud-based endpoint, or another operational component within a larger software ecosystem.

In one embodiment, the computing environment (700) operates in a single-device configuration. In such an embodiment, the processor (710), memory (720), model storage (730), embedding store (740), candidate store or queue (750), inference engine (760), network interface (770), and accelerator (780), where present, are located within one physical device or tightly integrated processing platform. A user or upstream application supplies an input through the client device or external system (790), the inference engine (760) performs baseline and recognition-based processing locally, and an output is returned without relying on external compute nodes other than optional communication endpoints. This embodiment is useful for controlled enterprise deployments, appliance-style deployments, on-device inference, or privacy-sensitive settings in which external data transfer is minimized.

In another embodiment, the computing environment (700) operates in a distributed configuration. In such an embodiment, the model storage (730) and baseline model execution may be located on one server or cluster, while the embedding store (740), candidate store or queue (750), and recognition-based inference logic implemented by the inference engine (760) may be located on another server or service tier. The network interface (770) coordinates transfer of embeddings, confidence values, candidate sets, retrieval results, or other data between those tiers. In another distributed arrangement, one service performs retrieval, another service performs base-model inference, and another service performs recognition-based scoring and downstream decision logic. Such distributed deployments do not alter the substance of the disclosed invention and remain within the scope of the computing environment (700) so long as the described recognition-based operations are performed by cooperating computational components.

In embodiments, the memory (720), embedding store (740), and candidate store or queue (750) can together support logging, auditability, reproducibility, and later analysis of recognition-based decisions. For example, the system can store intermediate semantic distances, recognition scale factors, coherence values, weighted sentiment outputs, reranking weights, combined scores, and candidate-selection outcomes associated with a given input. In one embodiment, such stored data can be used to compare a recognition-augmented decision path against a baseline decision path. In another embodiment, such data can be used for debugging, policy review, system validation, or performance tuning. In another embodiment, stored intermediate values can be used to provide downstream explanations or to reconstruct the sequence of computations applied to a particular input or candidate set.

The computing environment (700) can also implement queue-based and streaming execution modes. In one embodiment, incoming text items, candidate sets, or retrieval results are placed in the candidate store or queue (750), and the inference engine (760) processes those items in batch order, priority order, or a dynamically updated order. In another embodiment, the candidate store or queue (750) stores partial candidate sets during incremental generation or incremental retrieval, allowing recognition-based weights to be recomputed as new candidates arrive. In another embodiment, the computing environment (700) operates as a streaming content-analysis pipeline in which the network interface (770) receives a sequence of text items and the inference engine (760) continuously produces weighted outputs, rankings, or control signals. This supports deployment in real-time moderation, conversational systems, live analytics, and other sequential processing environments.

In embodiments, the disclosed computing environment (700) supports method claims, system claims, and computer-readable-medium-style implementations. For example, machine-readable instructions stored in the memory (720), model storage (730), or another non-transitory storage medium can cause the processor (710) to receive one or more outputs from a baseline model, compute one or more recognition-based values using the disclosed workflows, and generate one or more downstream outputs. In another embodiment, the computing environment (700) itself, including the processor (710), memory (720), model storage (730), embedding store (740), candidate store or queue (750), inference engine (760), network interface (770), and accelerator (780), can form the system that carries out the disclosed operations. This implementation language is useful because the disclosed invention is not limited to purely abstract mathematical treatment and instead includes concrete machine-executed structures and data-handling components.

The computing environment (700) can support the disclosed model-agnostic posture. In one embodiment, the processor (710) and inference engine (760) receive outputs from a baseline model stored in the model storage (730) and apply recognition-based computations without changing the stored model parameters. In another embodiment, the model storage (730) stores a separately fine-tuned model, but the recognition-based workflows still remain distinct computational stages carried out by the inference engine (760). In another embodiment, the baseline model is accessed remotely through the network interface (770), and the recognition-based post-processing logic is executed locally or by another downstream service. In each case, the computing environment (700) supports the architectural distinction between baseline model generation and recognition-based modulation, scoring, reranking, or selection.

In some embodiments, the computing environment (700) can execute fewer than all disclosed recognition-based workflows. For example, the inference engine (760) can generate recognition-enhanced embeddings and stop there, can compute only coherence scores, can compute only confidence-weighted sentiment outputs, or can compute only reranking weights. In other embodiments, the inference engine (760) can execute two or more workflows together and can optionally compute a combined score for final candidate comparison. This modularity at the computing-environment level mirrors the modularity of the disclosed functional architecture and permits selective deployment according to task requirements, compute budget, latency constraints, and integration targets.

Accordingly, FIG. 7 illustrates a computing environment (700) in which one or more processors (710), memory (720), model storage (730), an embedding store (740), a candidate store or queue (750), an inference engine (760), a network interface (770), an accelerator (780), and a client device or external system (790) cooperate to carry out one or more of the disclosed recognition-based natural language processing operations. This computing implementation provides concrete machine-executed structure for receiving baseline model outputs, computing recognition-based semantic, coherence, confidence-weighted, reranking, and optional combined-score values, storing intermediate and final data, communicating with external systems, and delivering downstream outputs in local, remote, batch, streaming, or distributed deployment environments. Referring to FIG. 1 and FIG. 7, the recognition-based natural language processing system (100) can be trained, deployed, and integrated in multiple ways while preserving the disclosed recognition-based post-processing architecture. In embodiments, the system (100) is deployed as a post-processing layer around the pre-trained language model or base language model (120) and executes within the computing environment (700). Under this architecture, the baseline model can generate base embeddings and raw prediction outputs (130), and those outputs can then be provided to one or more of the recognition semantic embedding module (140), the recognition contextual coherence module (150), the recognition sentiment analysis module (160), the recognition token reranking module (170), and, where used, the combined scoring module (180). This deployment posture preserves the model-agnostic structure described in the supporting outline and draft by allowing the disclosed workflows to operate on outputs of existing NLP systems rather than requiring redesign of the underlying model architecture.

In one embodiment, the system (100) is used in a no-retraining configuration. In such an embodiment, the pre-trained language model or base language model (120) is already trained before the disclosed recognition-based workflows are applied, and the processor (710) together with the memory (720) executes the recognition-based computations without modifying stored model weights in the model storage (730). The baseline model therefore remains fixed during deployment, while the disclosed post-processing logic operates on its outputs at inference time. This no-retraining posture is useful because it allows the disclosed workflows to be added to existing production systems, benchmark pipelines, enterprise deployments, and third-party model stacks without requiring additional labeled training data, gradient computation, optimizer configuration, or retraining infrastructure. The original draft expressly supports this deployment posture by stating that all four modules operate on outputs of any pre-trained model and require no fine-tuning or labeled data for deployment in embodiments.

In another embodiment, the system (100) is implemented as a post-processing wrapper around an upstream model. In such an embodiment, the pre-trained language model or base language model (120) can be invoked by the inference engine (760), after which the resulting base embeddings and raw prediction outputs (130) are passed into a wrapper layer that executes one or more of the modules (140), (150), (160), (170), and (180). The wrapper can be implemented as an application-level middleware layer, an inference hook, a callable library, a pipeline stage, a service endpoint, or another software component positioned downstream of the upstream model's primary output generation. This wrapper-based embodiment is useful because it preserves a clean architectural distinction between baseline model generation and recognition-based modulation, coherence scoring, confidence weighting, reranking, and optional combined scoring. It also allows selective activation of one subsystem only, two or more subsystems together, or a fuller integrated stack depending on the deployment target.

In another embodiment, the baseline model may itself be fine-tuned, adapted, or otherwise customized before or during deployment, while the disclosed recognition-based modules still remain distinct computational stages. In such an embodiment, the model storage (730) can store a fine-tuned checkpoint, domain-adapted model, retrieval-specialized model, classifier-specialized model, or another customized baseline model artifact. The inference engine (760) can execute that fine-tuned baseline model to produce base embeddings and raw prediction outputs (130), and the recognition-based workflows can then operate on those outputs in the same general manner described elsewhere herein. Thus, the phrase “post-processing” does not exclude embodiments in which the baseline model has undergone prior fine-tuning. Rather, it refers to the architectural fact that the disclosed recognition-based modules operate on outputs produced by the baseline model, whether that baseline model is frozen in original pre-trained form or adapted for a particular task or domain.

The disclosed system (100) is also compatible with transformer-based embodiments. In one embodiment, the pre-trained language model or base language model (120) is a transformer model, including an encoder-only model, decoder-only model, or encoder-decoder model. In such embodiments, the base embeddings and raw prediction outputs (130) can include contextual token embeddings, hidden states, pooled embeddings, logits, confidence-associated outputs, beam-search candidates, or retrieval-support signals produced by a transformer inference pipeline. The recognition semantic embedding module (140) can operate on transformer-produced token embeddings, the recognition contextual coherence module (150) can operate on transformer-derived enhanced embeddings, the recognition sentiment analysis module (160) can operate on classifier outputs derived from transformer representations, and the recognition token reranking module (170) can operate on transformer-linked candidate scores or retrieval outputs. The original draft expressly identifies compatibility with BERT-, GPT-, RoBERTa-, LLaMA-, and Mistral-class systems in embodiments, which supports transformer-oriented deployment without requiring framework lock-in.

In addition to transformer-based deployments, the disclosed system (100) is compatible with embedding-model embodiments. In one embodiment, the pre-trained language model or base language model (120) is an embedding-producing model that generates vector representations for tokens, phrases, sentences, passages, or documents. In such embodiments, the base embeddings and raw prediction outputs (130) can be produced by a word-embedding model, contextual embedding model, retrieval embedding model, sentence encoder, multimodal embedding model, or other vector-producing model. The recognition semantic embedding module (140) can then generate recognition-enhanced embeddings using context-derived embedding comparisons, and the recognition contextual coherence module (150) can compute coherence values over those embeddings. The original draft specifically identifies compatibility with word embeddings such as Word2Vec and GloVe, contextual embeddings such as BERT and RoBERTa, and even multimodal models in embodiments, thereby supporting broad embedding-model integration so long as suitable vector outputs are available.

In embodiments, the disclosed system (100) is framework agnostic. This means that the modules (140), (150), (160), (170), and (180) can be implemented in different machine-learning software ecosystems without changing the substance of the recognition-based computations themselves. In one embodiment, the system is implemented using a Python-based pipeline and a transformer library. In another embodiment, the system is implemented in a tensor-based environment supporting batched vector arithmetic and inference acceleration. In another embodiment, the system is deployed in a model-serving environment that exposes inference results through a runtime-neutral interface. The original draft expressly states that the disclosed system integrates with HuggingFace Transformers, PyTorch, TensorFlow, JAX, and ONNX Runtime in embodiments, which supports framework-agnostic implementation so long as the environment can generate or receive the needed model-derived quantities and execute the recognition-based arithmetic.

The training and deployment posture of the system (100) also supports hardware-flexible execution. In one embodiment, the system is deployed on a single device. In another embodiment, the system is deployed on a server or across multiple nodes. In another embodiment, the system is deployed as a cloud service. The supporting outline expressly states that the system can be deployed on a single device, on a server, across multiple nodes, as a cloud service, or as a library integrated into an NLP framework, and further states that the accelerator (780) can be used for lower-latency inference while the network interface (770) can support remote inference, streaming analytics, semantic search, or conversational AI deployments. This supports hardware-diverse and topology-diverse embodiments without changing the disclosed recognition-based functional structure.

In one embodiment, the disclosed system (100) is deployed as an application programming interface. In such an embodiment, the client device or external system (790) submits a query, prompt, text payload, candidate set, or other NLP-relevant input to the computing environment (700) through the network interface (770), and the computing environment (700) returns one or more recognition-processed outputs. Those outputs can include recognition-enhanced embeddings, coherence scores, weighted sentiment outputs, reranked candidates, selected candidates, combined scores, or other downstream decision outputs. The original draft expressly identifies a SaaS API embodiment as part of the commercial deployment path, which supports API-based deployment as a recognition-enhanced NLP endpoint. Such an embodiment is useful for enterprise search, conversational AI, content moderation, customer analytics, and other services that benefit from a remotely callable recognition-based post-processing layer.

In another embodiment, the disclosed system (100) is deployed as a software development kit or library. In such an embodiment, one or more of the modules (140), (150), (160), (170), and (180) are packaged as callable software components, such as a language-specific package, local inference library, plugin, extension module, middleware layer, or framework-integrated utility. The original draft expressly identifies an SDK embodiment, including a Python package embodiment, and also describes integration with major NLP frameworks. In embodiments, such a deployment allows developers to wrap an existing model or pipeline with the disclosed recognition-based computations through a local library call, model hook, or pipeline extension. This SDK or library embodiment is particularly useful where the deploying party wishes to incorporate the disclosed recognition-based logic directly into an existing product stack or workflow engine without making remote service calls for every inference.

In another embodiment, the disclosed system (100) is deployed as a cloud-integrated post-processing plugin or service. In such an embodiment, a cloud-hosted baseline model generates outputs, and the disclosed recognition-based modules receive those outputs either within the same cloud environment or in a connected downstream processing stage. The original draft identifies integration with cloud-hosted model platforms in embodiments, which supports deployment in environments where baseline language models are accessed as managed services rather than locally hosted weights. In such an embodiment, the recognition-based workflows can still remain distinct and independently controllable, even if the upstream model inference is performed by a third-party hosted service. This deployment posture is useful because it preserves the model-agnostic and integration-friendly nature of the disclosed invention while matching modern cloud-based inference workflows.

In some embodiments, the disclosed training and deployment posture also supports staged validation and commercial rollout. The original draft describes a prototype and validation pathway in which the four modules are first implemented on top of baseline models, then evaluated on multiple NLP benchmarks, then accelerated in GPU and FPGA embodiments, and then transitioned into industry pilot and commercial deployment embodiments. That pathway supports the proposition that the disclosed system can be introduced incrementally: first as a research or benchmark layer, then as a hardware-accelerated service, and then as a production-grade API, SDK, plugin, or enterprise integration component. Although such staged rollout is not required for the invention to operate, it shows that the disclosed training and deployment embodiments are commercially and operationally flexible.

In embodiments, the system (100) can be integrated into multiple application domains without changing the core recognition-based architecture. The original draft identifies conversational AI, semantic search, sentiment analytics, content moderation, machine translation, healthcare NLP, legal/compliance NLP, and educational technology as example commercial application areas. In each such case, the modules operate on outputs of an underlying model and provide recognition-based semantic, coherence, confidence-weighting, reranking, or combined-score improvements as downstream layers. This supports the proposition that the disclosed system is not limited to a single product vertical, but can instead be integrated into many classes of NLP systems so long as those systems produce suitable model-derived inputs for the recognition-based workflows. In one integration embodiment, the recognition semantic embedding module (140) and the recognition contextual coherence module (150) are used together in a conversational AI or response-generation stack. The baseline model generates candidate responses, the recognition semantic embedding module (140) refines context-sensitive representations, and the recognition contextual coherence module (150) scores coherence of candidate responses before final output selection. In another integration embodiment, the recognition token reranking module (170) is used with a retrieval system to rerank passages before they are sent to a generator. In another integration embodiment, the recognition sentiment analysis module (160) is used with a moderation or analytics stack to suppress low-confidence classifications and prioritize higher-confidence interpretive outputs. In another integration embodiment, the combined scoring module (180) aggregates two or more of these signals into a final semantic prediction output (680). These application-specific integrations do not change the underlying architectural logic, but illustrate how the disclosed modules can be selectively deployed in real systems. The disclosed training, deployment, and integration embodiments are therefore intentionally broad in engineering form while narrow in technical substance. They preserve the model-agnostic posture of the draft, allow no-retraining and post-processing wrapper deployments, accommodate fine-tuned baseline models, support transformer-based and embedding-model implementations, and permit framework-agnostic, API-based, SDK-based, library-based, server-based, single-device, distributed-node, and cloud-service deployment forms. At the same time, these embodiments do not expand the invention beyond the disclosed four-module NLP architecture and optional combined-score pathway. Rather, they describe practical ways in which that already-disclosed architecture can be instantiated, packaged, deployed, and integrated in real computational environments.

Accordingly, referring to FIG. 1 and FIG. 7, the recognition-based natural language processing system (100) can be deployed as a post-processing layer around the pre-trained language model or base language model (120) within the computing environment (700), can operate without modifying stored model weights in no-retraining embodiments, can also operate downstream of fine-tuned baseline models, can be implemented with transformer-based or embedding-producing models, can be realized in framework-agnostic software environments, and can be exposed through APIs, SDKs, cloud deployments, or integrated software libraries. These training, deployment, and integration embodiments provide practical implementation flexibility while remaining fully aligned with the disclosed recognition-based NLP invention. Referring collectively to FIGS. 1-9, the disclosed system supports a variety of variations and fallback embodiments that preserve the same underlying recognition-based natural language processing architecture while providing flexibility for implementation, claiming, amendment, and downstream deployment. In embodiments, these variations do not change the core invention, but instead describe different ways in which the disclosed modules, inputs, parameters, candidate types, context definitions, and computational pathways can be selected, combined, narrowed, or adapted while remaining within the same disclosed framework. The purpose of these fallback embodiments is to ensure that the invention is supported across narrower and broader implementations without requiring introduction of unrelated subject matter or later expansion beyond the presently disclosed architecture.

In one class of fallback embodiments, the recognition-based natural language processing system (100) can use fewer than all disclosed subsystems. For example, the system (100) can be configured to use only the recognition semantic embedding module (140), only the recognition contextual coherence module (150), only the recognition sentiment analysis module (160), only the recognition token reranking module (170), or any combination of two or more of those modules. In one embodiment, the recognition semantic embedding module (140) is used alone to improve context-sensitive token representations for ambiguity resolution or question answering. In another embodiment, the recognition contextual coherence module (150) is used alone to score generated text quality or segment a document into topically coherent sections. In another embodiment, the recognition sentiment analysis module (160) is used alone to confidence-weight interpretive outputs in moderation or analytics settings. In another embodiment, the recognition token reranking module (170) is used alone to rerank retrieved passages, candidate answers, or generation hypotheses. Thus, the invention is not limited to embodiments in which all four modules are active at the same time.

In another class of fallback embodiments, the system (100) can use two or more subsystems together without requiring all four. In one embodiment, the recognition semantic embedding module (140) and the recognition contextual coherence module (150) are used together so that recognition-enhanced embeddings are generated first and coherence is then computed over those recognition-enhanced embeddings. In another embodiment, the recognition token reranking module (170) is combined with the recognition contextual coherence module (150) so that candidate ranking is informed by both candidate relevance and structural quality of associated text. In another embodiment, the recognition sentiment analysis module (160) is combined with the recognition token reranking module (170) in a moderation or prioritization pipeline where candidates are weighted both by relevance and by confidence-weighted sentiment intensity. In another embodiment, the recognition semantic embedding module (140), the recognition token reranking module (170), and the recognition contextual coherence module (150) are used together while the recognition sentiment analysis module (160) is omitted. These combinations preserve the disclosed modular posture while supporting narrower claim sets and deployment-specific configurations.

In a further class of fallback embodiments, the combined scoring module (180) is optional. In one embodiment, the combined scoring module (180) is present and receives an alignment score input (610), a coherence score input (620), a confidence-weighted sentiment input (630), and a reranking weight input (640) to produce a final semantic prediction output (680). In another embodiment, the combined scoring module (180) is omitted entirely, and the downstream task module (190) receives outputs directly from one or more of the modules (140), (150), (160), and (170). In still another embodiment, the combined scoring module (180) is present but receives fewer than all four illustrated inputs. For example, the final semantic prediction output (680) can be generated from only the alignment score input (610) and the reranking weight input (640), or from only the coherence score input (620) and the reranking weight input (640), or from another subset of the available inputs. Accordingly, the combined score is a supported but optional integration layer rather than a mandatory component of every embodiment.

The recognition semantic embedding workflow (200) also supports multiple fallback embodiments. In one embodiment, the context window (230) is a fixed window of size K centered around a selected token. In another embodiment, the context window (230) is adaptive, such that the size or content of the window varies according to punctuation, discourse structure, sentence boundaries, speaker turns, sequence length, semantic density, or another criterion. In another embodiment, the context window (230) is sentence-bounded, such that context is drawn only from the same sentence as the selected token. In another embodiment, the context window (230) is paragraph-bounded or conversation-history bounded. In another embodiment, the context window (230) includes retrieved context, external supporting context, or another broader contextual region associated with the selected token or sequence. These fallback embodiments preserve the same core context-sensitive embedding refinement logic while supporting narrower definitions of context where appropriate for a particular claim set or deployment target.

The context embedding generator (240) similarly supports multiple fallback embodiments. In one embodiment, the context embedding is computed as a simple mean of the embeddings within the context window (230). In another embodiment, the context embedding is computed as a weighted mean in which different context tokens contribute different amounts based on position, recency, importance, syntactic role, retrieval relevance, or another weighting factor. In another embodiment, the context embedding generator (240) can use pooled or aggregated representations derived from the available context embeddings so long as the result remains a context-derived embedding suitable for comparison with the selected base embedding. Thus, the invention is not limited to arithmetic averaging as the only possible context-aggregation mechanism.

The semantic distance computation stage (250) also supports different fallback embodiments. In one embodiment, the semantic distance is computed as a cosine distance between the context embedding and the selected base embedding. In another embodiment, the semantic distance is computed as a Euclidean distance. In another embodiment, another nonnegative divergence or separation quantity is used so long as it reflects contextual mismatch and can serve as a nonnegative input to the recognition scale factor computation stage (260). These variations are expressly useful for supporting dependent claims and for preserving flexibility in implementation where different embedding spaces or application domains make one metric more convenient than another. Regardless of the selected metric, the recognition scale factor computation stage (260) continues to apply the same recognition-based scaling logic through the recognition coverage function.

The recognition-enhanced embedding output (270) also admits fallback embodiments regarding scope of application. In one embodiment, recognition-enhanced embeddings are produced for every token in the token sequence (210). In another embodiment, recognition-enhanced embeddings are produced only for a selected subset of tokens, such as ambiguous tokens, content-bearing words, named entities, or tokens associated with low-confidence interpretation. In another embodiment, the sense-selection or ambiguity-resolution output (280) is used in a direct disambiguation task, whereas in another embodiment the recognition-enhanced embedding output (270) is passed downstream without any explicit sense-selection stage. Thus, the same disclosed workflow supports both full-sequence and targeted token-level embodiments. The recognition contextual coherence workflow (300) likewise supports multiple fallback embodiments. In one embodiment, the sentence or text segment (310) is a sentence. In another embodiment, the sentence or text segment (310) is a paragraph, passage, response, translation output, document section, or another text unit. In one embodiment, the token-pair generator (330) generates all token pairs for the text unit. In another embodiment, the token-pair generator (330) generates only a subset of token pairs, such as pairs within a selected distance window, pairs involving content-bearing tokens, pairs spanning discourse regions, or pairs selected under a computational budget. In one embodiment, the enhanced embedding input set (320) comprises recognition-enhanced embeddings. In another embodiment, the enhanced embedding input set (320) comprises base embeddings where the recognition semantic embedding workflow has not been applied. In one embodiment, the coherence score output (370) is a normalized average of weighted pairwise terms. In another embodiment, the coherence score output (370) is a weighted average or another aggregate measure derived from the weighted coherence terms. These fallback embodiments preserve the same recognition-based coherence logic while accommodating different compute budgets, data structures, and downstream uses.

The coherence-based decision output (380) also supports different fallback embodiments. In one embodiment, the coherence-based decision output (380) is a segmentation marker indicating a likely topic boundary where coherence falls below a running average or another comparison baseline. In another embodiment, the coherence-based decision output (380) is a quality score used to rank generated text candidates. In another embodiment, the coherence-based decision output (380) is a filtering signal used to suppress low-coherence text from a generation or retrieval pipeline. In another embodiment, the coherence-based decision output (380) is omitted and only the coherence score output (370) is retained. These fallback forms preserve the disclosed coherence computation while allowing the operational effect of the coherence result to vary by application.

The recognition sentiment analysis workflow (400) also supports a range of fallback embodiments. In one embodiment, the text input for sentiment analysis (410) is a review, message, sentence, or document fragment, and the raw sentiment score (420) is a polarity score. In another embodiment, the raw sentiment score (420) is a toxicity value, moderation-risk value, emotional-intensity value, approval score, or another interpretive scalar. In one embodiment, the classifier confidence (430) is a posterior probability. In another embodiment, the classifier confidence (430) is derived from a logit margin, confidence head, ensemble agreement quantity, or another certainty-related measure, provided it is transformed into a usable nonnegative value. In one embodiment, the weighted sentiment output (460) is used directly as a downstream signal. In another embodiment, the moderation or analytics decision output (470) is generated based on the weighted sentiment output (460). In another embodiment, the weighted sentiment output (460) is passed into the combined scoring module (180). These variations preserve the same confidence-sensitive recognition-weighting logic while allowing sentiment-like interpretation to be implemented across different classification settings.

The recognition token reranking workflow (500) also supports multiple fallback embodiments with respect to candidate type, score type, normalization, and downstream use. In one embodiment, the candidate token, passage, or document set (510) comprises candidate tokens. In another embodiment, it comprises passages, documents, answer candidates, beam-search hypotheses, search-result snippets, or other candidate outputs. In one embodiment, the relevance score input (520) is already nonnegative. In another embodiment, the nonnegative score transform (530) is used because the incoming score requires shifting, clipping, rectification, or another conversion before the recognition reranking weight is computed. In one embodiment, the reranking weight computation stage (540) generates only the ranked candidate list (550). In another embodiment, normalized candidate weights (560) are also computed. In another embodiment, the selected candidate output (570) is a single top candidate, while in still another embodiment the selected candidate output (570) is a weighted subset of candidates. Thus, the reranking workflow supports soft reranking in both single-winner and multi-candidate embodiments.

Particular candidate-type fallback embodiments are especially useful for amendment flexibility. In one embodiment, the workflow (500) is applied to retrieval-augmented generation, where the candidate token, passage, or document set (510) comprises retrieved passages. In another embodiment, the workflow (500) is applied to beam search reranking, where the candidate token, passage, or document set (510) comprises generation hypotheses. In another embodiment, the workflow (500) is applied to semantic search, where the candidate token, passage, or document set (510) comprises documents or passages returned in response to a query. In another embodiment, the workflow (500) is applied to answer selection or snippet ranking. These candidate-type variations are useful because they provide direct support for dependent claims tied to specific NLP applications while staying within the same underlying reranking mechanism. The combined semantic prediction workflow (600) also supports fallback embodiments. In one embodiment, the mixture weight generator (650) derives the mixture coefficients from X_opt and all four inputs are used by the combined score computation stage (660). In another embodiment, fewer than all four inputs are used. In one embodiment, the candidate comparison or selection stage (670) selects the highest-scoring candidate. In another embodiment, the candidate comparison or selection stage (670) retains a top-ranked subset. In another embodiment, the final semantic prediction output (680) is subjected to a threshold, margin test, comparative rule, or fallback escalation rule. In another embodiment, the final semantic prediction output (680) is passed directly to the downstream task module (190) without additional thresholding. These variations preserve the same combined-score logic while allowing different downstream control strategies and claim focus points.

The disclosed invention also supports baseline-model compatibility fallback embodiments. In one embodiment, the pre-trained language model or base language model (120) is a transformer-based model. In another embodiment, it is an embedding-producing model. In another embodiment, it is a classifier, retrieval model, or hybrid model that provides one or more of the needed embeddings, confidence values, relevance values, or candidate outputs. In one embodiment, the disclosed recognition-based workflows operate without modifying model weights. In another embodiment, the baseline model may have been separately fine-tuned before use, while the recognition-based modules still operate as distinct computational stages. These compatibility embodiments are useful because they preserve the model-agnostic nature of the disclosed system and allow fallback claim positions focused either on frozen-model deployment or on downstream use with adapted baseline models.

The disclosed invention further supports fallback embodiments regarding hardware and deployment form. In one embodiment, the system is implemented on a single device. In another embodiment, the system is implemented on a server. In another embodiment, the system is implemented across multiple nodes, such as distributed services or a cloud deployment. In one embodiment, the accelerator (780) is omitted. In another embodiment, the accelerator (780) comprises a GPU. In another embodiment, the accelerator (780) comprises an FPGA, TPU, or another specialized accelerator. In one embodiment, the system is exposed through an application programming interface. In another embodiment, it is implemented as a library or software development kit. These deployment and hardware fallback embodiments are useful because they provide claim support for different computational implementations while remaining anchored to the same recognition-based NLP workflows.

In some embodiments, one or more of the illustrated outputs can be omitted where not required by a narrower implementation. For example, the sense-selection or ambiguity-resolution output (280), the coherence-based decision output (380), the moderation or analytics decision output (470), the normalized candidate weights (560), or the final semantic prediction output (680) may be omitted in implementations that use only the corresponding intermediate score or representation. In other embodiments, those outputs are expressly retained because they are operationally useful in a deployed system. This flexibility is beneficial because it allows narrower method claims and broader system claims to be supported by the same disclosure. The fallback embodiments also support narrowing along application lines without altering the disclosed core invention. In one embodiment, the system is used for conversational AI and ambiguity resolution. In another embodiment, the system is used for content moderation or sentiment analytics. In another embodiment, the system is used for semantic search, answer ranking, or retrieval-augmented generation. In another embodiment, the system is used for machine translation quality estimation or document segmentation. In another embodiment, the system is used for summarization, ranking of generated responses, or response filtering. These application-focused variations are useful because they allow downstream claiming and amendment to focus on particular commercial or technical use cases already directionally supported by the disclosed module structure.

The disclosed variations and fallback embodiments are intended to preserve robustness, amendment flexibility, and prosecution optionality while remaining within the presently disclosed technical framework. They do not add a new theory, new subsystem family, or unrelated subject matter. Instead, they identify disclosed alternatives for distance metric choice, context window size and definition, sentence-level or paragraph-level or conversation-history context, candidate type, single-module and multi-module deployments, optional combined-score use, optional normalization, optional baseline-model compatibility, and optional hardware implementation. Accordingly, referring collectively to FIGS. 1-9, the disclosed reference numerals support a variety of narrower and broader embodiments that remain triangle-locked to the present specification and figure plan and that can be used to support later amendment, fallback dependent claiming, or deployment-specific claim strategy without requiring expansion beyond the disclosed recognition-based natural language processing invention.

What is claimed is:

1. A computer-implemented method for natural language processing, the method comprising:
receiving, by one or more processors, an input text or query; providing the input text or query to a pre-trained language model or base language model; receiving, from the pre-trained language model or base language model, a token sequence and a base embedding set corresponding to tokens of the token sequence; defining, for a selected token of the token sequence, a context window; computing a context embedding for the selected token from base embeddings within the context window; computing a semantic distance between the context embedding and a base embedding of the selected token; computing, from the semantic distance, a recognition scale factor as a ratio of (i) the semantic distance to (ii) a sum of the semantic distance and a constant X_opt, wherein X_opt is a constant defined as phi divided by pi; generating a recognition-enhanced embedding for the selected token using the recognition scale factor and a difference between the context embedding and the base embedding of the selected token; and providing the recognition-enhanced embedding to a downstream natural language processing task.

2. The method of claim 1, wherein the context window is a fixed positional window of size K around the selected token.

3. The method of claim 1, wherein the context window is adaptive based on at least one of punctuation, a sentence boundary, a clause boundary, a discourse marker, a speaker turn, a retrieved-context limit, or semantic density.

4. The method of claim 1, wherein computing the context embedding comprises computing a mean of the base embeddings within the context window.

5. The method of claim 1, wherein computing the context embedding comprises computing a weighted mean of the base embeddings within the context window.

6. The method of claim 1, wherein computing the semantic distance comprises computing a cosine distance between the context embedding and the base embedding of the selected token.

7. The method of claim 1, wherein computing the semantic distance comprises computing a Euclidean distance between the context embedding and the base embedding of the selected token.

8. The method of claim 1, further comprising selecting, from a plurality of candidate senses for the selected token, a candidate sense based on the recognition-enhanced embedding.

9. The method of claim 8, wherein selecting the candidate sense comprises preferring a candidate sense associated with a smaller recognition correction magnitude or a smaller recognition correction magnitude proxy.

10. A natural language processing system comprising:
one or more processors; and memory storing instructions that, when executed by the one or more processors, cause the one or more processors to: receive an input text or query; provide the input text or query to a pre-trained language model or base language model; receive, from the pre-trained language model or base language model, base embeddings and raw prediction outputs; compute a coherence score for a text unit by aggregating pairwise similarity contributions among embeddings and weighting the pairwise similarity contributions according to positional distance using a recognition coverage mapping that, for a nonnegative input r and a constant X_opt equal to phi divided by pi, produces a weight equal to r divided by the sum of r and X_opt; compute a confidence-weighted sentiment output from a raw sentiment score and a classifier confidence using the recognition coverage function; compute a reranking weight for each of a plurality of candidates from a relevance score input using the recognition coverage function; generate, from at least one of the coherence score, the confidence-weighted sentiment output, or the reranking weight, an output for a downstream natural language processing task.

11. The system of claim 10, wherein the instructions further cause the one or more processors to compute the coherence score by aggregating pairwise similarity contributions among recognition-enhanced embeddings.

12. The system of claim 10, wherein computing the coherence score comprises clipping a negative pairwise similarity value to zero before weighting according to positional distance.

13. The system of claim 10, wherein the downstream natural language processing task comprises document segmentation based on the coherence score.

14. The system of claim 10, wherein the downstream natural language processing task comprises moderation or analytics based on the confidence-weighted sentiment output.

15. The system of claim 10, wherein the plurality of candidates comprises retrieved passages and the reranking weight is used to rerank the retrieved passages before the retrieved passages are provided as context to a generative model.

16. The system of claim 10, wherein the plurality of candidates comprises beam-search hypotheses and the reranking weight is used to rerank the beam-search hypotheses during sequence generation.

17. A non-transitory computer-readable medium storing instructions that, when executed by one or more processors, cause the one or more processors to:
receive, from a pre-trained language model or base language model, an alignment-related quantity, a coherence-related quantity, a confidence-weighted quantity, and a reranking-related quantity associated with a candidate output;
compute mixture weights from X_opt=phi/pi;
compute a combined score for the candidate output from the alignment-related quantity, the coherence-related quantity, the confidence-weighted quantity, and the reranking-related quantity using the mixture weights; and
select or rank the candidate output based on the combined score by accepting the candidate output when the combined score exceeds an acceptance threshold tau.

18. The non-transitory computer-readable medium of claim 17, wherein accepting the candidate output further requires that a score margin between a highest-scored candidate output and a next-highest-scored candidate output is at least a margin m.

19. The non-transitory computer-readable medium of claim 17, wherein selecting or ranking further comprises identifying ambiguity when at least two candidate outputs are within a closeness interval epsilon of a highest combined score, and escalating to a fallback handling mode when the ambiguity is identified.

20. The non-transitory computer-readable medium of claim 19, wherein identifying ambiguity comprises determining that at least two candidate outputs are within a closeness interval epsilon of a highest combined score, and wherein escalating to the fallback handling mode comprises at least one of (i) requesting additional context, (ii) expanding a retrieval top-k set, (iii) re-ranking using an additional feature, or (iv) re-running a scoring operation using a larger context window.
